(19) United States
(12) Patent Application Publication
(10) Pub. No.: US 2023/0068492 A1
(43) Pub. Date: Mar. 2, 2023

(54) GENERATING USER INTERFACES COMPRISING DYNAMIC ACCORDION-BASED TRANSPORTATION USER INTERFACE ELEMENTS TO IMPROVE COMPUTER SYSTEM EFFICIENCY

(71) Applicant: Lyft, Inc., San Francisco, CA (US)

(72) Inventors: Sushant Deepak Bhadkamkar, Mountain View, CA (US); David Florian Kayode Ikuye, San Francisco, CA (US); Sravanthi Kadali, San Francisco, CA (US); Charles Parker Spielman, San Francisco, CA (US)

(21) Appl. No.: 17/461,602

(22) Filed: Aug. 30, 2021

(51) Int. Cl. G06F 3/0482; G06F 3/0484; G06F 16/951; G06F 16/9538

(52) U.S. Cl. CPC G06F 3/0482; G06F 3/04847; G06F 16/951; G06F 16/9538

(57) ABSTRACT

The present application discloses systems, methods, and computer-readable media that can intelligently generate a graphical user interface (GUI) having expandable and/or collapsible interface elements that flexibly, efficiently, and accurately provide transportation mode options and transportation sub-options on a computing device. For example, based on monitored transportation features of provider devices and requestor devices, the disclosed systems can dynamically determine a first tier of transportation mode option interface elements and a second tier of transportation sub-option interface elements within accordion-based elements that are operable to display and hide the second tier. Additionally, the disclosed systems can, based on the monitored transportation features of provider devices and requestor devices, dynamically control the expanded (or collapsed) states, positioning, availability states, and/or preselection of accordion-based selectable transportation mode option interface elements and/or transportation sub-option interface elements within a GUI.

### BACKGROUND

Recent years have seen significant development in transportation matching systems that utilize web and mobile applications to manage real-time on-demand transportation requests from requestor devices. For example, on-demand transportation matching systems can match provider devices with requestor devices to provide transportation across a variety of geographic locations. This often involves communications from an on-demand transportation system via web or mobile applications on provider devices and requestor devices to coordinate various aspects of a transportation service (e.g., a pickup location, a drop-off location, etc.). Although conventional transportation matching system attempt to coordinate various aspects of transportation services through mobile applications, such conventional transportation matching systems face a number of technical shortcomings, particularly with regard to efficient, accurate, and flexible user interfaces to coordinate rapidly changing and complex dynamics through limited screen spaces of mobile devices operating the mobile applications.

### SUMMARY

The disclosure describes one or more embodiments of systems, methods, and non-transitory computer readable media that provide benefits and solve one or more of the foregoing or other problems. In particular, the disclosed systems can monitor and analyze signals across devices of a transportation matching system to generate a graphical user interface (GUI) having intelligent, expandable and/or collapsible interface elements that efficiently, flexibly, and accurately provide transportation mode options and transportation sub-options on a device. For example, based on monitored transportation features of provider devices and requestor devices, the disclosed systems can dynamically determine a first tier of transportation mode option interface elements and a second tier of transportation sub-option interface elements within accordion-based elements that are operable to display and hide the second tier. Additionally, the disclosed systems can, based on the monitored transportation features of provider devices and requestor devices, dynamically control expanded (or collapsed) states of accordion interface elements, intelligently position user interface elements within (or outside of) a viewable region, dynamically modify elements over time based on different availability states, and/or automatically preselect accordion-based selectable transportation mode option interface elements and/or transportation sub-option interface elements within a GUI. In this manner, the disclosed systems can effectively provide flexible and efficient access to relevant (and current) transportation mode options and transportation sub-options within limited spaces of mobile device screens implementing a transportation system across computer networks.

Additional features and advantages of one or more embodiments of the present disclosure will be set forth in the description which follows.

### BRIEF DESCRIPTION OF THE DRAWINGS

The detailed description is described with reference to the accompanying drawings in which:

FIG. 1 illustrates a block diagram of an environment for implementing a dynamic-accordion-interface system in accordance with one or more implementations.

FIG. 2 illustrates an overview diagram of a dynamic-accordion-interface system determining and displaying a tiered-hierarchy of transportation option user interface elements based on transportation features in accordance with one or more implementations.

FIGS. 3A and 3B illustrate a dynamic-accordion-interface system utilizing transportation features to determine expansion states within a tiered-hierarchy of transportation option user interfaces elements in accordance with one or more implementations.

FIG. 3C illustrates a dynamic-accordion-interface system providing an accordion interface element operable to hide or display nested transportation sub-option interface elements in accordance with one or more implementations.

FIGS. 4A-4C illustrate a dynamic-accordion-interface system utilizing transportation features to determine activation states within a tiered-hierarchy of transportation option user interface elements in accordance with one or more implementations.

FIGS. 5A and 5B illustrate a dynamic-accordion-interface system determining and displaying a tiered-hierarchy of transportation option user interface elements based on rankings from transportation features in accordance with one or more implementations.

FIG. 6 illustrates a dynamic-accordion-interface system modifying elements within a graphical user interface based on selections of nested transportation sub-option interface elements in accordance with one or more implementations.

FIGS. 7A and 7B illustrate a dynamic-accordion-interface system displaying second tier nested sub-option interface elements for various types of first tier option interface elements in accordance with one or more implementations.

FIG. 8 illustrates a flowchart of a series of acts for displaying a tiered-hierarchy of transportation option user interface elements in accordance with one or more implementations.

FIG. 9 illustrates a block diagram of a computing device in accordance with one or more implementations.

FIG. 10 illustrates an example environment for a transportation matching system in accordance with one or more implementations.

### DETAILED DESCRIPTION

The disclosure describes one or more embodiments of a dynamic-accordion-interface system that can analyze monitored transportation features of provider devices and requestor devices to intelligently determine an arrangement of (and a number of) selectable transportation mode option and transportation sub-option interface elements within a GUI having a tiered-hierarchy of transportation option user interface elements. In particular, the dynamic-accordion-interface system can display, within a GUI, first tier transportation mode options (for different transportation modes) that expand and/or collapse to display a second tier of selectable transportation sub-options (for different variations of a transportation mode service). Additionally, the dynamic-accordion-interface system can utilize monitored transportation features of provider devices and requestor devices to intelligently construct (and/or change) an accordion-based GUI. For example, the dynamic-accordion-interface system can analyze transportation features to determine an expanded (or collapsed) state of various accordion interface elements, to arrange and position particular interface elements within a viewable region, to dynamically update interface elements to reflect ephemeral options, and/or to preselect accordion-based selectable transportation mode option and sub-option interface elements within the GUI. Indeed, the dynamic-accordion-interface system dynamically generates an accordion-based GUI that is quickly and efficiently navigable to select transportation options in real time on smaller mobile device screens.

For instance, the dynamic-accordion-interface system can determine transportation features from a plurality of provider devices and requestor devices corresponding to a transportation matching system. More specifically, in one or more embodiments, the dynamic-accordion-interface system can monitor various aspects of provider devices and requestor devices operating in a transportation system to determine real-time (or near real-time) statistics of provider devices and requestor devices (e.g., locations, quantity, a number of transportation requests), historical activity, and/or user preferences. Furthermore, the dynamic-accordion-interface system can also monitor other environmental factors (e.g., events in a geographical area, weather, time) within an operating region of a transportation matching system.

In addition, the dynamic-accordion-interface system can determine, based on the transportation features, a tiered-hierarchy of transportation option user interface elements having multiple tiers. Particularly, the dynamic-accordion-interface system can analyze the transportation features (and information corresponding to a requestor device) to select, for presentation in a tiered-hierarchy of interface elements, a first tier of transportation mode interface elements and a second tier of nested transportation sub-option interface elements that correspond to relevant transportation mode offers and sub-offers for the requestor device. In addition, the dynamic-accordion-interface system can also analyze the transportation features (and the information corresponding to a requestor device) to determine the expanded (or collapsed) state of transportation mode interface elements (e.g., to display or hide the second tier of transportation sub-option interface elements), the arrangement of the transportation mode interface elements, and/or the preselection of a transportation mode interface element and/or a transportation sub-option interface element.

Additionally, the dynamic-accordion-interface system can provide the tiered-hierarchy of transportation option user interface elements for display, within a GUI of a requestor device. For instance, the dynamic-accordion-interface system can provide one or more accordion selectable elements corresponding to a first tier for display while hiding a second tier. In some implementations, the dynamic-accordion-interface system can intelligently determine expanded (and/or collapsed) states and provide, for display within the GUI of the requestor device, a first tier transportation mode interface element that is expanded to present a second tier of transportation sub-option interface elements for the transportation mode corresponding to the first tier transportation mode interface element. The dynamic-accordion-interface system can further detect an indication of a selection of an accordion selectable element corresponding to the first tier transportation mode interface element to collapse (or expand) the second tier of transportation sub-option interface elements.

In addition, due to real-time (or near real-time) changes in transportation features (and information corresponding to a requestor device) in a transportation system, the dynamic-accordion-interface system can dynamically update transportation sub-option interface elements, the expanded (or collapsed) states, positioning above or below a viewable region, activation states for ephemeral transportation services, and/or preselection of accordion-based selectable transportation mode option and sub-option interface elements within the GUI. To illustrate, in some embodiments, the dynamic-accordion-interface system determines that a transportation sub-option is inoperable (or unavailable) based on changes in transportation features in a transportation system. Subsequently, the dynamic-accordion-interface system can dynamically update the tiered-hierarchy of transportation option user interface elements by deactivating (e.g., removing or making non-selectable) a transportation sub-option interface element corresponding to the inoperable transportation sub-option. In addition, the dynamic-accordion-interface system can also dynamically change transportation pickup times and/or transportation request rates corresponding to the nested transportation sub-option interface elements (within a GUI of a requestor device).

As mentioned above, conventional systems often face a number of technical shortcomings in graphical user interface accuracy, efficiency, and flexibility. For example, due to limited screen space, conventional systems oftentimes do not display granular options for transportation services that provide an accurate visualization of options available within a transportation matching system. Rather, in many cases, the conventional systems provide one dimensional options (i.e., single select options) that fail to account for nuanced changes in a constantly changing transportation service environment. Consequently, many conventional systems present a graphical user interface with non-granular options that may inaccurately visualize available options within a rapidly changing and complex transportation matching system.

Furthermore, in order to provide more granular selection of transportation options within limited screen spaces of GUIs in mobile devices, many conventional systems provide inefficient graphical user interfaces that often require numerous navigational steps. In particular, conventional systems oftentimes fail to provide efficient accessibility to functionalities and/or options within the limited screens spaces of GUIs in mobile devices. To resolve this and in order to select specific sub-options for a transportation mode within a transportation matching application, many conventional systems utilize multiple navigational steps to navigate between different user interfaces (or windows) with transportation options to fit the functionalities and/or options within the limited screen spaces of GUIs in mobile devices.

Moreover, conventional systems often generate inflexible and rigid GUIs. For instance, in order to fit within the limited screen spaces of GUIs in mobile devices, many conventional systems limit the number of transportation options available within the GUIs. Accordingly, conventional systems cannot easily present multiple options on mobile devices and, therefore, limit the amount of information available to users on the GUIs. In addition, many conventional systems also wait for a user interface navigational change or a refresh request to update information corresponding to the limited number of transportation options within a GUI. Indeed, such conventional systems often rigidly present outdated and non-customized transportation options within the limited screen spaces of GUIs in mobile devices.

The dynamic-accordion-interface system can provide numerous advantages, benefits, and practical applications relative to conventional systems. For example, the dynamic-accordion-interface system generates improved graphical user interfaces that accurately, efficiently, and flexibly coordinate dynamic aspects of transportation services through limited screen spaces of GUIs in mobile devices that operate transportation matching applications. To illustrate, in one or more embodiments, the dynamic-accordion-interface system generates an accurate visualization of transportation options available within a transportation matching system by displaying granular options for different transportation modes utilizing one or more intelligent accordion selectable elements. In particular, the dynamic-accordion-interface system can intelligently select and provide accordion selectable elements corresponding to first tier transportation mode options that are operable to display and hide a second tier of nested transportation sub-options for improved granularity in the limited screen spaces of GUIs in mobile devices. Furthermore, by dynamically updating the transportation mode options and/or the transportation sub-options using changes in monitored transportation features, the dynamic-accordion-interface can present a graphical user interface with granular options that accurately visualize available options within a rapidly changing transportation matching system.

In addition to accuracy, the dynamic-accordion-interface system also improves the efficiency of GUIs for requestor devices by providing efficient accessibility to functionalities and/or options within the limited screens spaces of GUIs in mobile devices with a reduction in navigational steps. For example, in some embodiments, by generating a GUI with a tiered-hierarchy of transportation option user interface elements having one or more accordion selectable elements corresponding to first tier of transportation mode options operable to display and hide the second tier transportation sub-options, the dynamic-accordion-interface system can provide access to more functionalities and/or options within a single GUI (without extensive navigation across multiple user interfaces) even when screen space is limited. Moreover, unlike many conventional systems, the dynamic-accordion-interface system can also utilize monitored transportation features to intelligently construct (and/or change) an accordion-based GUI. Indeed, by intelligently constructing the accordion-based GUI, the dynamic-accordion-interface improves the efficiency of a GUI by reducing the number of navigational steps required to access functionality and/or options that are relevant to a requestor operating a requestor device.

In addition to improved accuracy and efficiency, the dynamic-accordion-interface system also generates GUIs that flexibly coordinate rapidly changing aspects of transportation services through limited screen spaces of mobile devices. For example, unlike conventional systems that limit the number of transportation options available within the GUIs, the dynamic-accordion-interface system generates a GUI that displays expansive options for different transportation modes utilizing one or more accordion selectable elements that are operable to display and hide a second tier of nested transportation sub-options for first tier transportation mode options in the limited screen spaces of GUIs in mobile devices. Furthermore, in contrast to the outdated and non-customized transportation options often displayed by conventional systems, the dynamic-accordion-interface system utilizes real-time (or near real-time) changes in transportation features to dynamically update the expanded states, positioning, availability states, and/or content of accordion-based selectable transportation mode option and sub-option interface elements within the GUI to present relevant options to a requestor operating a requestor device. Accordingly, the dynamic-accordion-interface system generates flexible GUIs that present a larger variety of options with up-to-date information.

As indicated by the foregoing discussion, the present disclosure utilizes a variety of terms to describe features and advantages of the dynamic-accordion-interface system. For example, as used herein, the term “transportation feature” refers to a characteristic, attribute, and/or condition associated with provider devices and/or requestor devices operating within a transportation matching system. In particular, the term “transportation feature” can refer to information corresponding to provider devices and/or requestor devices, information corresponding to a region (or area) in which the provider devices and/or requestor devices operate, activity of provider devices and/or requestor devices, and/or other metrics corresponding to predicted provider device and/or requestor device activity.

For example, a transportation feature can include, but is not limited to, a transportation request (e.g., pickup location, destination location, time), provider device locations, number of online provider devices, number of transportation requests, historical activity of provider devices, and/or environmental attributes (e.g., weather, events in a region, traffic). In addition, a transportation feature can include information of a requestor device such as, but not limited to, historical activity of provider devices and/or requestor devices, a location of a requestor device, and/or user preferences corresponding to a requestor device. As described in greater detail below, the dynamic-accordion-interface system determines a tiered-hierarchy of transportation option user interface elements and dynamically controls an accordion-based GUI by determining the expanded states, positioning, availability states, and/or preselection of accordion-based selectable transportation mode option and sub-option interface elements within the GUI based on determined transportation features.

As further used herein, the term “tiered-hierarchy of transportation option user interface elements” refers to a collection of user interface elements (and/or options) organized into a hierarchical arrangement (e.g., organized into or more options with one or more nested sub-options). In particular, in one or more embodiments, a tiered-hierarchy of transportation option user interface elements include a tier of user interface elements for transportation mode options and transportation sub-options. For example, a tiered-hierarchy of transportation option user interface elements includes a first tier of one or more transportation mode elements that correspond to transportation mode options and a second tier of nested transportation sub-option interface elements corresponding to transportation sub-options for one or more transportation mode options. A tiered-hierarchy can include a variety of numbers of different tiers (e.g., first tier, a second tier, and a third tier of options).

Moreover, as used herein, the term “transportation mode” refers to a particular type or category of transportation service provided within a transportation matching application. For example, a transportation mode can include a selection of a type of transportation service such as, but not limited to, a vehicle type corresponding to a transportation service, a shared or non-shared type of transportation service, a delivery (e.g., parcel delivery) transportation service, a delayed transportation service (e.g., delayed transportation with a different transportation value or price), and/or a public transit service. Furthermore, as used herein, the term “transportation mode interface element” refers to a user interface element that visually displays an option for a transportation mode (i.e., a transportation mode option). In one or more embodiments, the transportation mode interface element is selectable and a selection of a particular transportation mode interface element indicates a transportation request using the transportation mode corresponding to particular transportation mode interface element.

Additionally, as used herein, the term “transportation sub-option” refers to a nested option that corresponds to a transportation mode option. In particular, a transportation sub-option can include an option that indicates a specific variation or preference in relation to a transportation mode option. For example, a transportation sub-option can include a specific transportation pickup time, transportation request rate, transportation vehicle type, pick-up location drop-off location, etc., corresponding to a transportation mode option. For example, the dynamic-accordion-interface system can determine and provide various transportation sub-options for a transportation mode option that specify different pickup times and different transportation request rates. In certain instances, the transportation sub-options can include transportation options such as, but not limited to, different pickup locations, destination locations, vehicles, drop off times, number of different shared requestors corresponding to a transportation request in the transportation service, and/or different routes for the transportation request.

Furthermore, as used herein, the term “transportation sub-option interface element” refers to a user interface element that visually displays a transportation sub-option. In one or more embodiments, the transportation sub-option interface element is selectable and a selection of a particular transportation sub-option interface element indicates a transportation request using a transportation mode having characteristics or features that match a particular transportation sub-option corresponding to the particular transportation sub-option interface element. Moreover, in one or more embodiments, the dynamic-accordion-interface system can nest one or more transportation sub-option interface elements under a transportation mode interface element (e.g., to nest transportation sub-options under a transportation mode).

As used herein, the term “accordion selectable element” refers to a selectable GUI element that is operable to display and hide tiered user interface elements in a tiered-hierarchy of transportation option user interface elements. For example, upon receiving a selection of an accordion selectable element, the dynamic-accordion-interface system can cause a GUI to expand (or display) second tier nested user interface elements (e.g., transportation sub-option interface elements) of a first tier user interface element (e.g., a transportation mode interface element). Likewise, upon receiving a selection of an accordion selectable element, the dynamic-accordion-interface system can also cause a GUI to collapse (or hide) second tier nested user interface elements of a first tier user interface element.

As also used herein, the term “viewable region of a graphical user interface” refers to a portion of a GUI that is within the boundaries of a screen of a client device. For example, a viewable region of a GUI includes a portion of a GUI that is visually observable by a user operating a requestor (or provider) device. Additionally, a non-viewable region of a GUI includes a portion of a GUI that is not visually observable by a user operating a requestor (or provider device) (e.g., by being outside an on-screen portion of a device).

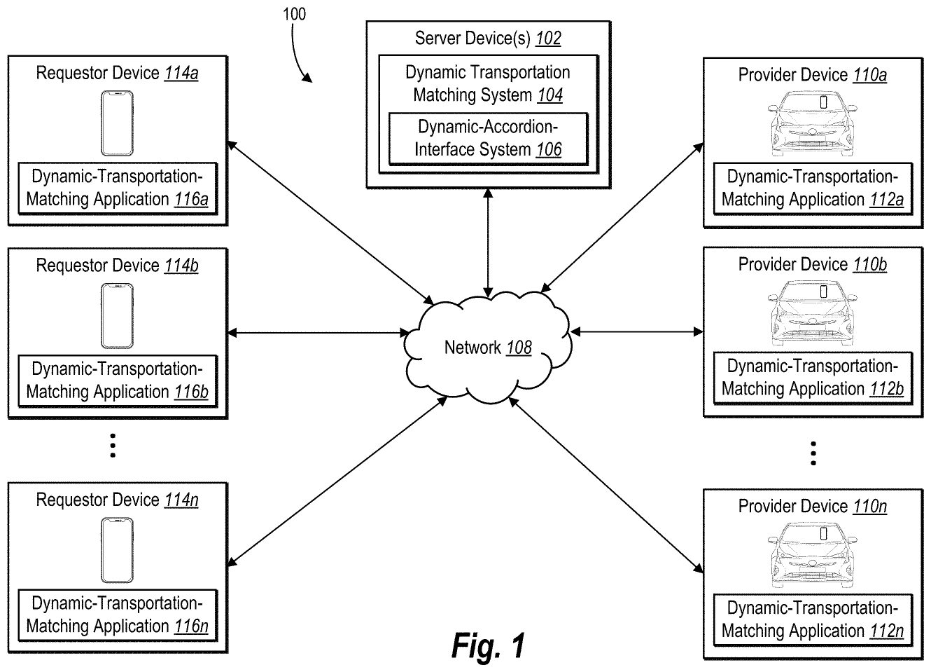

Turning now to the figures, FIG. 1 illustrates a schematic diagram of system 100 (or environment) in which a dynamic-accordion-interface system 106 can operate in accordance with one or more embodiments. As shown in FIG. 1, the system 100 includes server device(s) 102 (which includes a dynamic transportation matching system 104 and the dynamic-accordion-interface system 106), provider devices 110a-110n, requestor devices 114a-114n, and a network 108. As further illustrated in FIG. 1, the server device(s) 102, the provider devices 110a-110n, and the requestor devices 114a-114n can communicate via the network 108. Although FIG. 1 illustrates the dynamic-accordion-interface system 106 being implemented by a particular component and/or device within the system 100, the dynamic-accordion-interface system 106 can be implemented, in whole or in part, by other computing devices and/or components in the system 100 (e.g., the requestor devices 114a-114n and/or the provider devices 110a-110n).

As shown in FIG. 1, the server device(s) 102 can include the dynamic transportation matching system 104. In one or more embodiments, the dynamic transportation matching system 104 can identify one or more matches between transportation requests (e.g., including pickup locations and destination locations) for requestor devices and provider devices. In particular, the dynamic transportation matching system 104 can provide transportation requests from requestor devices to provider devices that fulfill the transportation requests (e.g., transport a requestor associated with a requestor device to a destination location). For instance, the dynamic transportation matching system 104 can utilize information corresponding to a transportation request (received from a requestor device) and information corresponding to available provider devices to select a provider device for the transportation request. Then, the dynamic transportation matching system 104 can transmit the transportation request to a selected provider device to fulfill the transportation request.

As also shown in FIG. 1, the dynamic transportation matching system 104 further includes the dynamic-accordion-interface system 106. In some embodiments, the dynamic-accordion-interface system 106 can determine transportation features corresponding to provider devices (e.g., provider devices 110a-110n) and requestor devices (e.g., requestor devices 114a-114n) that interact with the dynamic transportation matching system 104. Furthermore, based on the transportation features, the dynamic-accordion-interface system 106 can intelligently construct (and/or change) an accordion-based GUI by determining the expanded (or collapsed) states, positioning, availability states for ephemeral transportation services, and/or preselection of accordion-based selectable transportation mode option and sub-option interface elements for the GUI. Moreover, the dynamic-accordion-interface system 106 can provide, for display within a GUI of a requestor device, the accordion-based GUI to include a first tier of transportation mode option interface elements and a second tier of transportation sub-option interface elements within the accordion-based elements that are operable to display and hide the second tier (in accordance with one or more embodiments herein).

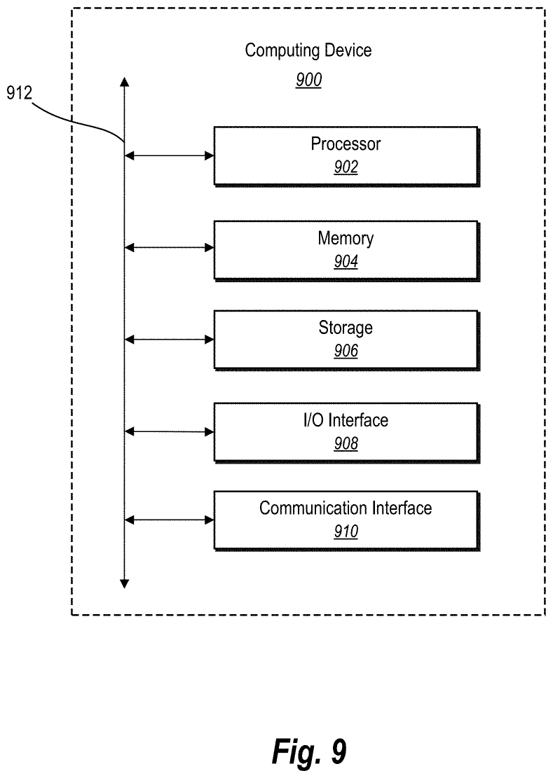

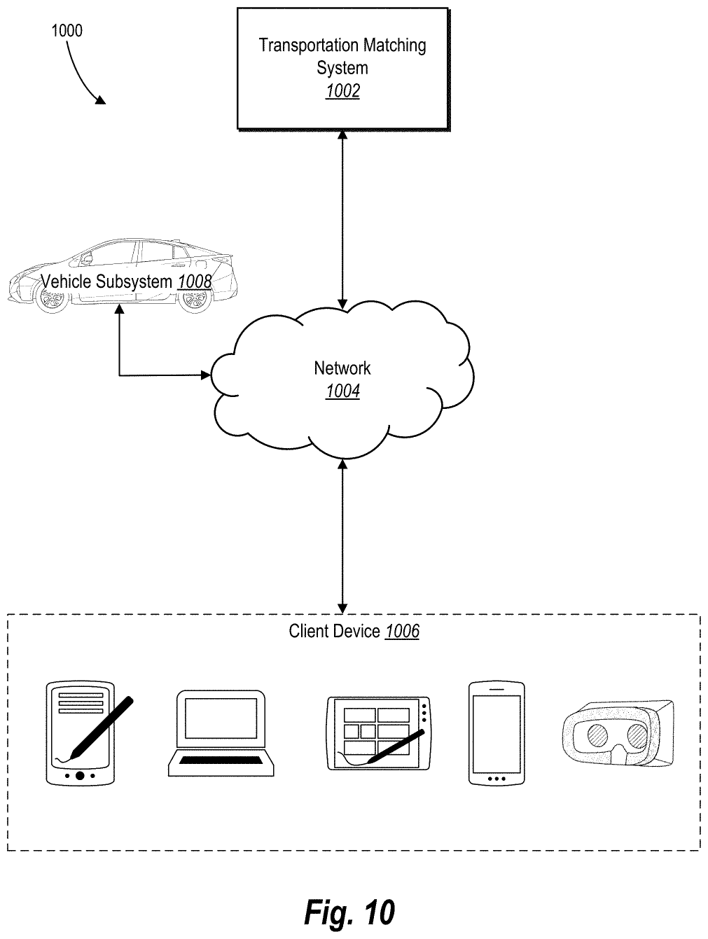

Additionally, as shown in FIG. 1, the system 100 includes the provider devices 110a-110n. In some instances, the provider devices 110a-110n may include, but are not limited to, mobile devices (e.g., smartphones, tablets) or other types of computing devices, including those explained below with reference to FIGS. 9 and 10. Indeed, the provider devices 110a-110n can include computing devices associated with (and/or operated by) providers and/or transportation vehicles (e.g., transportation vehicles of providers or autonomous vehicles). Moreover, the system 100 can include a different number of provider devices.

As also shown in FIG. 1, the provider devices 110a-110n include dynamic-transportation-matching applications 112a-112n. In some embodiments, the dynamic-transportation-matching applications 112a-112n can include instructions that (upon execution) cause the provider devices 110a-110n to perform various actions. Such instructions may cause a provider device to present dispatch instructions (e.g., via a graphical user interface displaying navigation information) for a vehicle associated with the provider device. Furthermore, such instructions may likewise cause a provider device to identify (or transmit) transportation features and/or present a graphical user interface to display a transportation matching application user interface that includes an accordion-based GUI (in accordance with one or more embodiments herein).

In addition, as illustrated in FIG. 1, the system 100 includes the requestor devices 114a-114n. For example, the requestor devices 114a-114n may include, but are not limited to, mobile devices (e.g., smartphones, tablets) or other types of computing devices, including those explained below with reference to FIGS. 9 and 10. Additionally, the requestor devices 114a-114n can include computing devices associated with (and/or operated by) requestors for transportation requests (or other services).

As also shown in FIG. 1, the requestor devices 114a-114n include dynamic-transportation-matching applications 116a-116n, which can include instructions that (upon execution) cause the requestor devices 114a-114n to perform various actions. For example, a requestor can interact with a dynamic-transportation-matching application (from the dynamic-transportation-matching applications 116a-116n) on a requestor device (from the requestor devices 114a-114n) to transmit a transportation request to the dynamic transportation matching system 104 (via the network 108). In addition, the such instructions may likewise cause a requestor device to identify (or transmit) transportation features and/or present a graphical user interface to display a transportation matching application user interface that includes an accordion-based GUI (in accordance with one or more embodiments herein). In some embodiments, the requestor devices 114a-114n (via the dynamic-transportation-matching applications 116a-116n) implements the dynamic-accordion-interface system 106 while receiving configurations for tiered-hierarchy of transportation option user interface elements from the server device(s) 102.

In one or more embodiments, the provider devices 110a-110n and the requestor devices 114a-114n correspond to one or more user accounts (e.g., user accounts stored at the server device(s) 102). For example, a requestor of a requestor device can establish a requestor account with login credentials and the provider of a provider device can establish a provider account with login credentials. These user accounts can include a variety of information regarding requestors/providers, including requestors/provider information (e.g., name, telephone number), vehicle information (e.g., vehicle type, license plate number), device information (e.g., operating system, memory or processing capability), payment information, purchase history, transportation history. Different accounts can also include various privileges associated with requestors and providers (e.g., privileges to access certain functionality via the transportation matching application, to provide transportation services, to submit transportation requests). The dynamic transportation matching system 104 can manage the provider devices 110a-110n and the requestor devices 114a-114n based on appropriate privileges associated with the corresponding user accounts (e.g., provider accounts and/or requestor accounts). Accordingly, providers and/or requestors can utilize multiple devices (e.g., multiple provider devices or multiple requestor devices) with the appropriate privileges associated with the corresponding accounts.

The present disclosure utilizes provider devices and requestor devices to refer to devices associated with these user accounts. Thus, in referring to a provider device or a requestor device, the disclosure and the claims are not limited to communications with a specific device, but any device corresponding to an account of a particular user. Accordingly, in using the term provider device, this disclosure can refer to any computing device corresponding to a provider account. Similarly, in using the term requestor device, this disclosure can refer to any computing device corresponding to a requestor account.

Additionally, as shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIGS. 9 and/or 10. Furthermore, although FIG. 1 illustrates the server device(s) 102, provider devices 110a-110n, and the requestor devices 114a-114n communicating via the network 108, the various components of the system 100 can communicate and/or interact via other methods (e.g., the server device(s) 102 and the requestor devices 114a-114n can communicate directly).

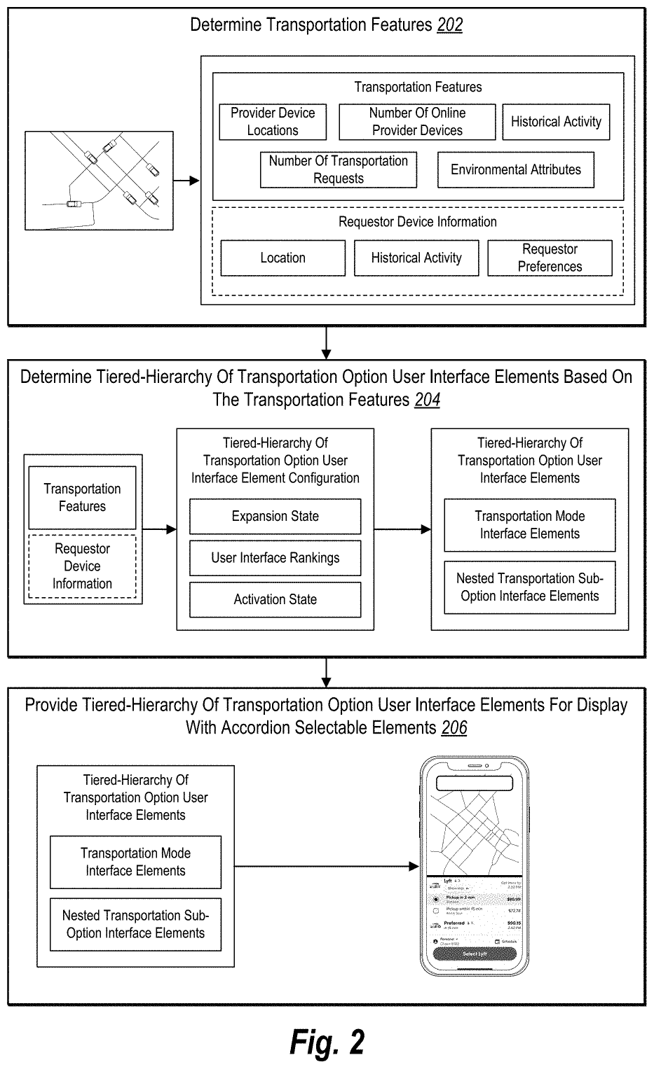

As mentioned above, the dynamic-accordion-interface system 106 can dynamically generate and display an accordion-based GUI having tiered-hierarchy of transportation option user interface elements based on monitored transportation features. For instance, FIG. 2 illustrates the dynamic-accordion-interface system 106 determining transportation features (and/or requestor device information). Moreover, FIG. 2 also illustrates the dynamic-accordion-interface system 106 determining a tiered-hierarchy of transportation option user interface elements and displaying the tiered-hierarchy of transportation option user interface elements based on the determined transportation features.

To illustrate, the dynamic-accordion-interface system 106 can determine transportation features from provider devices and requestor devices from monitoring provider and requestor devices (e.g., in real time or near-real time) and/or from historical data of provider and requestor devices that include activity in a specific geographical area. For example, the dynamic-accordion-interface system 106 can monitor of provider and requestor devices that are operating (or have operated) within a geographical area corresponding to a requestor device that is requesting a transportation request. In addition, the dynamic-accordion-interface system 106 can also utilize requestor device information from the requestor device that is requesting a transportation request.

For example, the dynamic-accordion-interface system 106 can monitor (or obtain), from provider devices, requestor devices, or another third-party data service, transportation features such as, but not limited to, provider device locations, number of online provider devices, number of transportation requests, environmental attributes, and/or historical activity. In certain instances, the dynamic-accordion-interface system 106 can identify provider device locations to calculate (or determine) transportation request values (e.g., a cost for the transportation request), estimated travel times, and/or routes for a transportation request having a start (e.g., pickup) and end (e.g., drop off) destination. Moreover, the dynamic-accordion-interface system 106 can also identify a number of online provider devices and/or a number of transportation requests to determine a supply of provider devices and a demand of transportation requests within a geographical area (e.g., to determine availability, travel time, and transportation request values). Furthermore, in some cases, the dynamic-accordion-interface system 106 can identify pre-scheduled transportation requests within a geographical area to determine a supply of provider devices and a demand of transportation requests within the geographical area.

Moreover, the dynamic-accordion-interface system 106 can identify environmental attributes within a geographical area as a transportation feature. To illustrate, the dynamic-accordion-interface system 106 can determine traffic patterns in a geographical area to determine ride times between a pickup and drop off location of a transportation request. Moreover, the dynamic-accordion-interface system 106 can also identify weather forecasts to determine demand of transportation requests and/or wait times for transportation requests. Furthermore, the dynamic-accordion-interface system 106 can also identify events (e.g., concerts, conventions, sporting events, festivals) occurring within a geographical area to determine demand of transportation requests and/or wait times for transportation requests. Moreover, the dynamic-accordion-interface system 106 can also identify types of transportation modes available corresponding to the active (or online) provider devices in a geographical area of the transportation request.

Additionally, the dynamic-accordion-interface system 106 can identify historical data of provider and requestor devices that include activity in a specific geographical area as transportation features. For instance, the dynamic-accordion-interface system 106 can identify historical data from provider device activities such as, but not limited to, historical transportation request completion times, historical transportation request acceptances, historical transportation request rejections, historical transportation request values, historical transportation mode availabilities, historical routes, and/or historical feedback or reviews associated with the provider devices. Furthermore, the dynamic-accordion-interface system 106 can identify historical data from requestor device activities such as, but not limited to, historical transportation request submissions, historical transportation mode option selections, and/or historical transportation sub-option selections).

In certain instances, the dynamic-accordion-interface system 106 also determines information of a requestor device (that is requesting a particular transportation request). For example, the dynamic-accordion-interface system 106 can identify information such as, but not limited to, a location, historical activity, and requestor preferences corresponding to the requestor device. More specifically, the dynamic-accordion-interface system 106 can identify a requestor device location to determine route times between the requestor device (e.g., a pickup location) and active provider devices within a geographical area that can service a transportation request submitted by the requestor device. Additionally, the dynamic-accordion-interface system 106 can identify historical activity associated with the requestor device such as, but not limited to, historical transportation mode option selections, historical transportation sub-option selections, and/or historical utilization of accordion-interface elements within a GUI of a dynamic-transportation-matching application.

Furthermore, the dynamic-accordion-interface system 106 can identify requestor user preferences corresponding to the requestor device as requestor device information. In particular, requestor user preferences can include pre-configured preferred transportation modes, preferred transportation sub-options for transportation modes, and/or preferred expansion states of accordion-interface elements. For example, the dynamic-accordion-interface system 106 can identify a requestor user preference that indicates that a specific transportation mode option should be a first option within a GUI of a dynamic-transportation-matching application and/or that transportation sub-options for a specific transportation mode option should be expanded within a GUI of a dynamic-transportation-matching application. As another example, the dynamic-accordion-interface system 106 can identify a requestor user preference that indicates that a specific transportation sub-option interface element should be selected within a GUI of a dynamic-transportation-matching application.

Furthermore, the dynamic-accordion-interface system 106 can utilize the determined transportation features (and/or requestor device information) with a recommendation engine to determine metrics and/or other outputs to determine a tiered-hierarchy of transportation option user interface elements (to display to the requestor device) for a particular transportation request. For example, the dynamic-accordion-interface system 106 can determine metrics and/or other outputs to determine transportation mode options, transportation sub-options, and one or more other configurations of the tiered-hierarchy of transportation option user interface elements that are relevant to the requesting requestor device. In some cases, the dynamic-accordion-interface system 106 can determine a metric and/or other output that evaluates a specific transportation mode option and/or corresponding transportation sub-options relative to a transportation request made by a requestor device in a specific geographic location.

For example, the dynamic-accordion-interface system 106 can determine a metric for particular transportation modes that includes a value to represent the ability of routes and/or provider device matches for the transportation request to service the transportation request from the requestor device within a threshold time and/or threshold transportation request value using the particular transportation modes. In some instances, the metric can include a value to indicate the likelihood of the requestor device selecting a particular transportation mode, route, transportation request value, and/or transportation sub-option (e.g., options corresponding to different estimated times of arrival or other service features). Indeed, the dynamic-accordion-interface system 106 can determine a metric by evaluation (or analyzing) monitored transportation features (and/or requestor device information) in relation to particular transportation mode options and/or transportation sub-options.

In some cases, the dynamic-accordion-interface system 106 determines a metric by analyzing transportation features (and/or requestor device information) for particular transportation modes and/or transportation sub-options utilizing a weighted objective function that evaluates a transportation request value gain, a conversion rate, and/or a transportation request volume gain in relation to the particular transportation modes and/or transportation sub-options. For instance, the dynamic-accordion-interface system 106 can utilize a weighted objective function that evaluates a transportation mode (or different sub-options for the transportation mode) to determine the transportation request value gain for the dynamic transportation matching system 104 if the transportation mode (or different sub-options for the transportation mode) are selected. Moreover, the dynamic-accordion-interface system 106 can utilize a weighted objective function that evaluates a transportation mode (or different sub-options for the transportation mode) to determine a conversion rate that represents a likelihood of the transportation mode or a particular transportation sub-option being selected by a requestor operating a requestor device. Additionally, the dynamic-accordion-interface system 106 can utilize a weighted objective function that evaluates a transportation mode (or different sub-options for the transportation mode) to determine a total transportation request volume gain (e.g., an increase in the utilization of the dynamic transportation matching system 104) if the transportation mode (or different sub-options for the transportation mode) are selected.

In some instances, the dynamic-accordion-interface system 106 can utilize metrics, preferences, and/or the other data described above from the transportation features (and/or requestor device information) to determine various aspects within the tiered-hierarchy of transportation option user interface elements. For example, the dynamic-accordion-interface system 106 can utilize the metrics, preferences, and/or the other data described above to identify (or determine) transportation modes and/or transportation sub-options to provide to a requestor device. In addition, the dynamic-accordion-interface system 106 can also utilize the metrics, preferences, and/or the other data described above to determine configurations for a tiered-hierarchy of transportation user interface elements (e.g., expanded/collapsed states, activation or availability states, ranked orders, pre-selections) that are favorable to a requesting user of a requestor device and/or favorable to transportation values and/or outcomes for the dynamic transportation matching system 104.

Indeed, as shown in FIG. 2, upon determining transportation features (and/or requestor device information) as described above, the dynamic-accordion-interface system 106 can determine a tiered-hierarchy of transportation option user interface elements based on the transportation features in an act 204. For example, as shown in the act 204 of FIG. 2, the dynamic-accordion-interface system 106 determines, during a configuration of the tiered-hierarchy of transportation option user interface elements, expansion states, user interface rankings, and/or activation states of one or more transportation mode interface elements and/or one or more nested transportation sub-option interface elements based on the transportation features (and/or the requestor device information). Indeed, as further shown in the act 204 of FIG. 2, the dynamic-accordion-interface system 106 determines a tiered-hierarchy of transportation option user interface elements that includes transportation mode interface elements and nested transportation sub-option interface elements (with the configured expansion states, user interface rankings, and/or activation state). In one or more embodiments, the dynamic-accordion-interface system 106 also identifies the transportation mode options (for the transportation mode option interface elements) and/or the transportation sub-options (for the transportation sub-option interface elements) based on the transportation features (and/or the requestor device information).

To illustrate, in some embodiments, the dynamic-accordion-interface system 106 can receive a transportation request from a requestor device and utilize the transportation request to identify available provider devices in a geographical area. For example, the dynamic-accordion-interface system 106 can identify available provider devices that are capable of fulfilling the transportation request from the requestor device. Then, the dynamic-accordion-interface system 106 can determine the types of transportation mode options that are available through the identified provider devices. In addition, the dynamic-accordion-interface system 106 can also determine the transportation sub-options that are available through the identified provider devices (e.g., pickup time options, transportation request rate options, vehicle type options, etc.).

Additionally, in reference to the act 204 of FIG. 2, the dynamic-accordion-interface system 106 can utilize the transportation features (and/or the requestor device information) with a transportation request to determine the metrics, preferences, and/or the other data (as described above) between available provider devices (and their transportation service modes) in a geographic area and the requestor device (that initiated a transportation request). Then, the dynamic-accordion-interface system 106 can utilize the metrics, preferences, and/or the other data to determine a set of transportation mode option interface elements for identified transportation modes to display on the requestor device. In particular, in one or more embodiments, the dynamic-accordion-interface system 106 can utilize the metrics, preferences, and/or the other data corresponding to the various candidate provider devices and associated transportation service modes to select a set of transportation mode options for the transportation request.

In addition, in reference to the act 204 of FIG. 2, the dynamic-accordion-interface system 106 can also utilize the transportation features (and/or the requestor device information) to determine various. For example, the dynamic-accordion-interface system 106 can determine metrics, preferences, and/or the other data for sub-options (e.g., different pickup times, different transportation rates, vehicle types, etc.) that are available from the provider devices in a geographical area of the requestor device. Then, in one or more embodiments, the dynamic-accordion-interface system 106 selects transportation sub-options for transportation mode options that are provided to the requestor device from various candidate transportation sub-options based on the metrics, preferences, and/or the other data.

Furthermore, in reference to the act 204 of FIG. 2, the dynamic-accordion-interface system 106 can utilize the transportation features to determine whether to set an expansion state for a transportation mode interface element. To illustrate, based on the transportation features, the dynamic-accordion-interface system 106 can selectively expand or collapse nested transportation sub-option interface elements of a transportation mode interface element. As an example, upon determining that a requestor device user is likely to select a particular transportation sub-option (based on the transportation features), the dynamic-accordion-interface system 106 can set an expansion state (to be expanded) for an accordion selectable element corresponding to a transportation mode interface element that includes the particular transportation sub-option interface element. In some cases, the dynamic-accordion-interface system 106 can selectively collapse the accordion selectable element corresponding to the transportation mode interface element having the particular transportation sub-option interface element based on determining that a particular requestor device user is not likely to select the particular transportation sub-option.

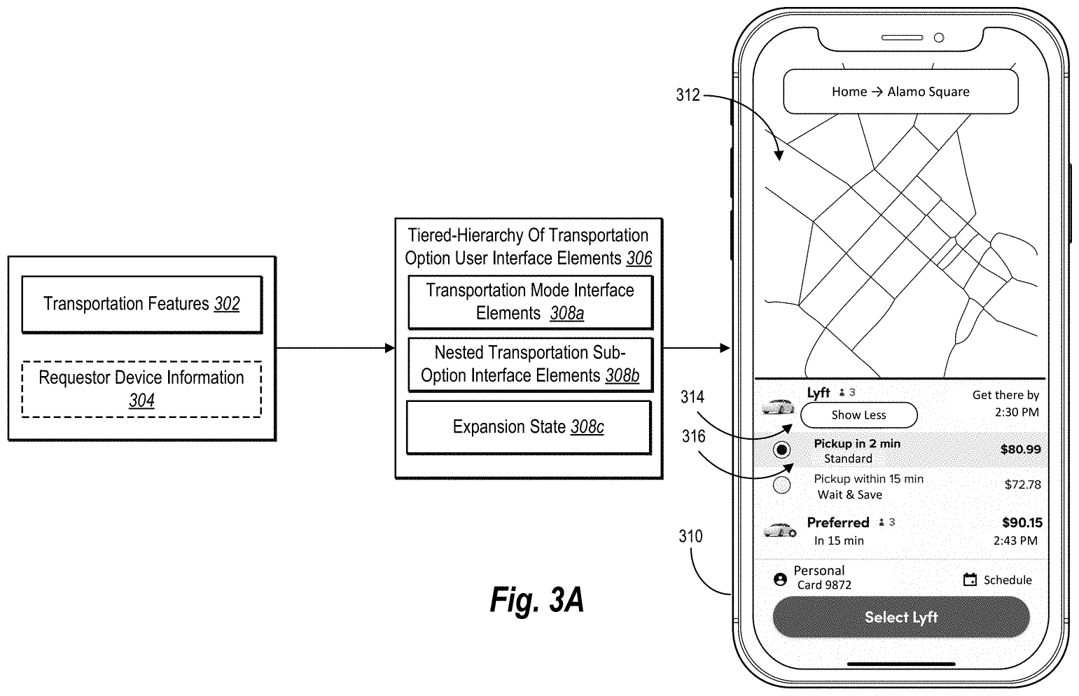

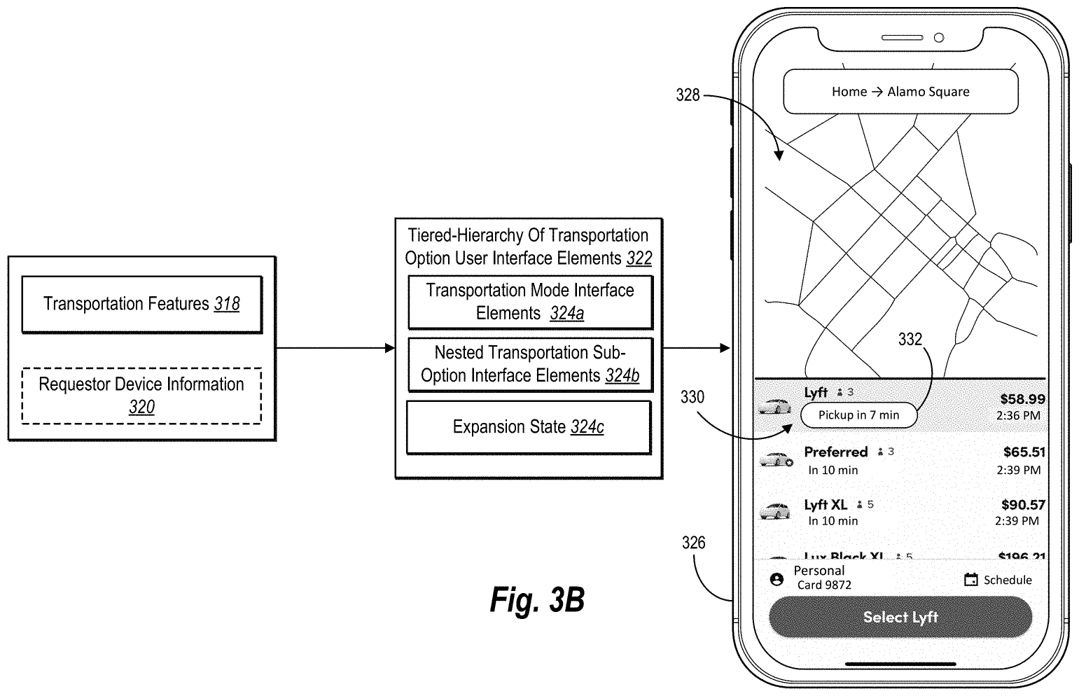

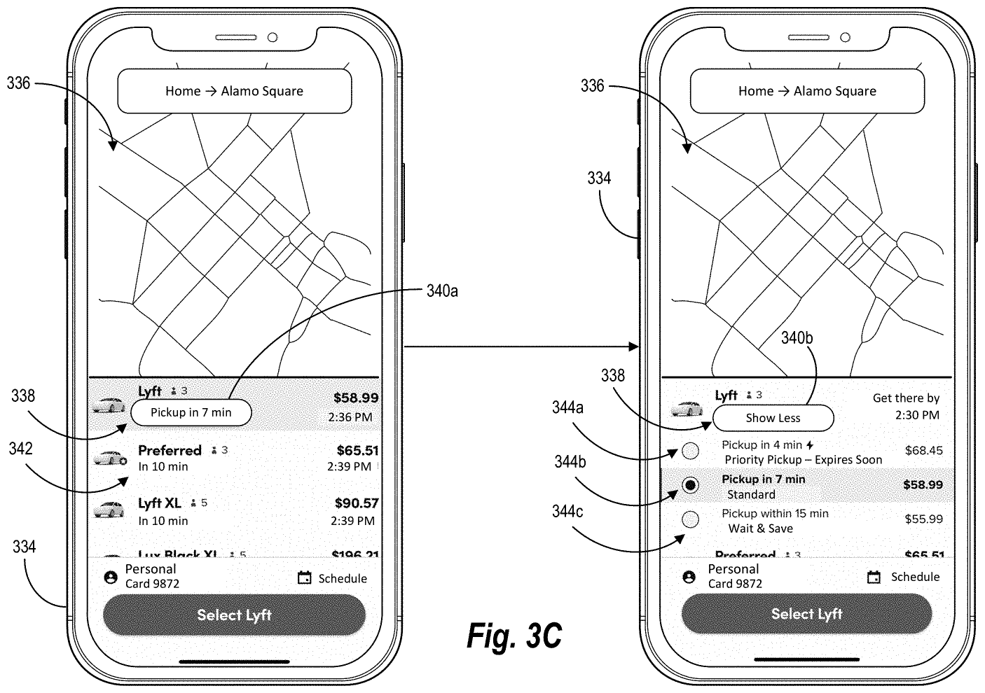

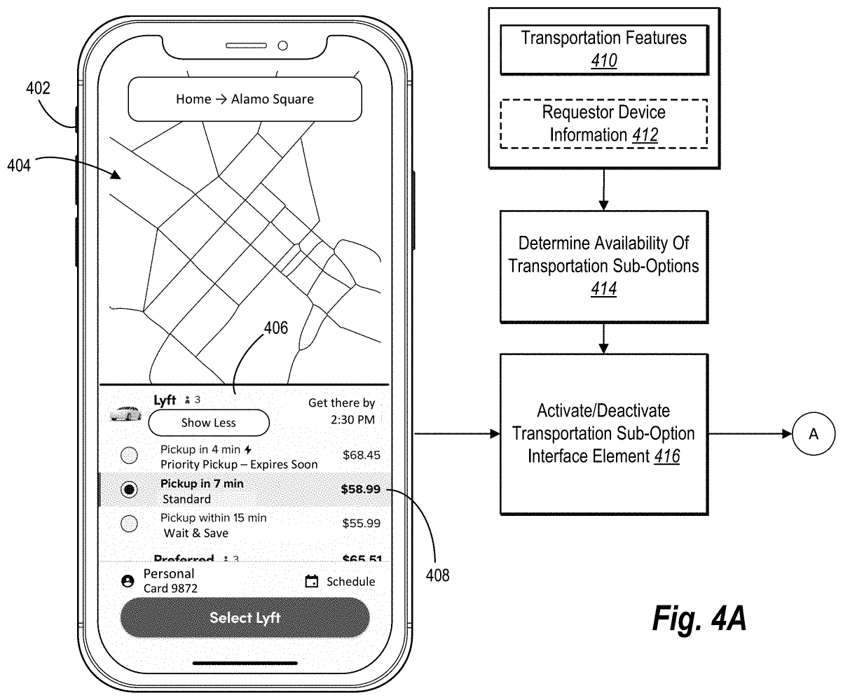

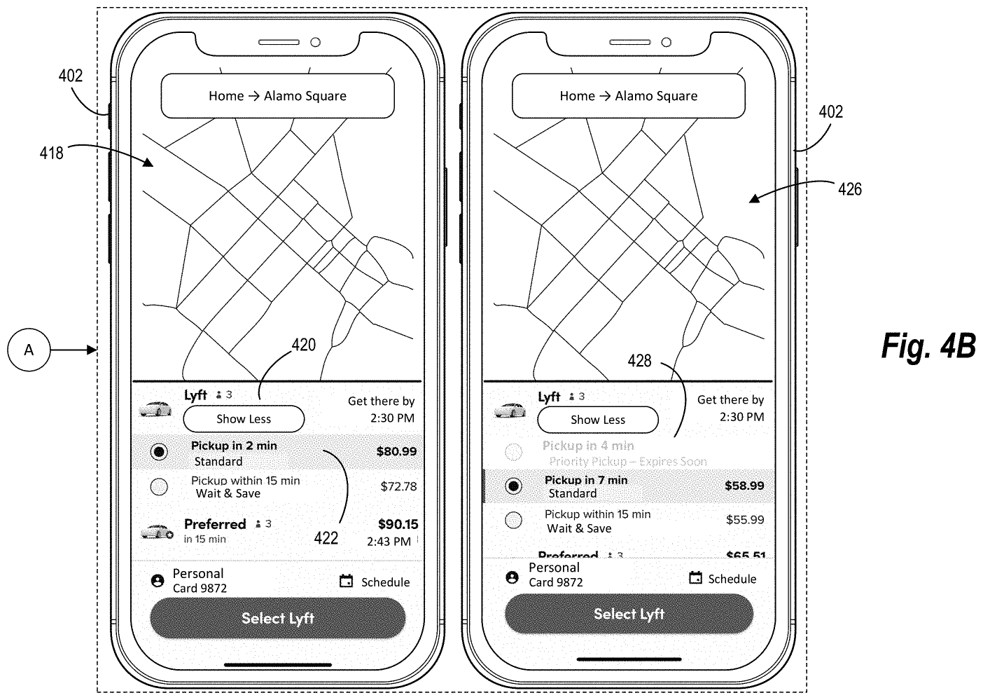

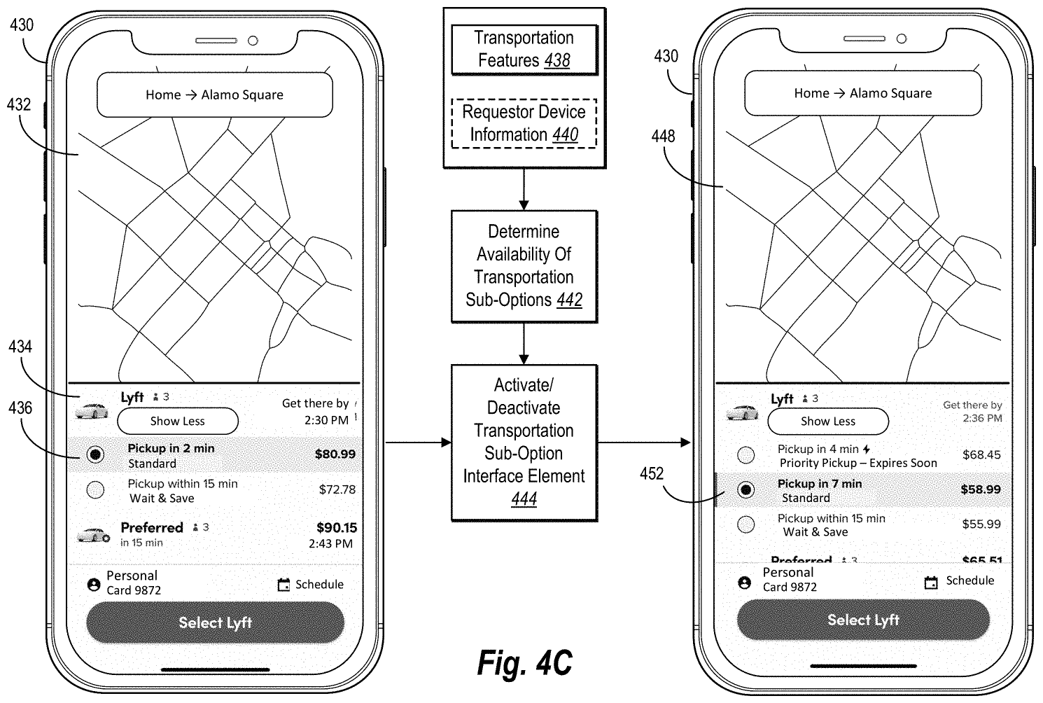

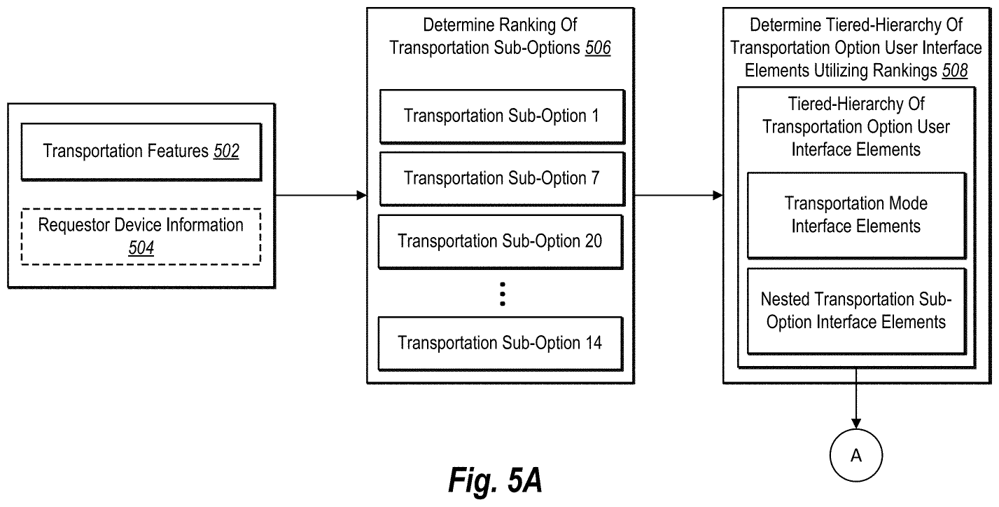

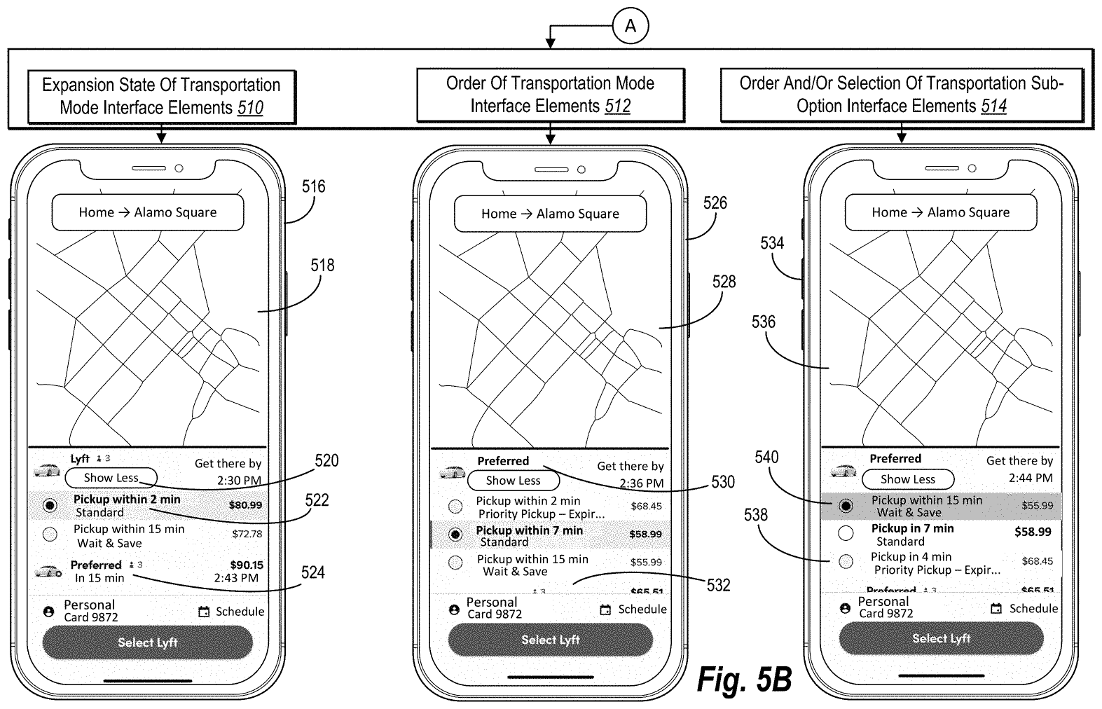

Indeed, additional detail regarding the dynamic-accordion-interface system 106 determining and setting an expansion state for a transportation mode interface element is provided below (e.g., in relation to FIGS. 3A and 3B). Furthermore, additional detail regarding the dynamic-accordion-interface system 106 determining and activating/deactivating transportation sub-options is provided below (e.g., in relation to FIGS. 4A-4C). Moreover, additional information regarding the dynamic-accordion-interface system 106 ranking transportation sub-options and configuring a tiered-hierarchy of transportation option user interface elements based on the rankings is provided below (e.g., in relation to FIGS. 5A and 5B).

Upon determining a tiered-hierarchy of user elements with expansion states, activation states, and/or user interface rankings, the dynamic-accordion-interface system 106 provides the tiered-hierarchy of user elements with accordion selectable elements for display within a GUI of a requestor device as shown in act 206 of FIG. 2. Indeed, as shown in the act 206 of FIG. 2, the dynamic-accordion-interface system 106 provides for display, within a GUI of a requestor device, accordion selectable elements operable to display or hide a second tier of interface elements. As mentioned above, the tiered hierarchy of user elements (and its expansion states, activation states, and/or user interface rankings) can be dynamically controlled/changed based on changes to transportation features and/or requestor device information.

For example, FIG. 3A illustrates the dynamic-accordion-interface system 106 utilizing transportation features (and/or requestor device information) to select expansion states 308c for transportation mode interface elements 308a and nested transportation sub-option interface elements 308b of a tiered-hierarchy of transportation option user interfaces elements 306. Indeed, the dynamic-accordion-interface system 106 determines the expansion state based on the transportation features 302 (and/or requestor device information 304) as described above.

To illustrate, as shown in FIG. 3A, the dynamic-accordion-interface system 106 can determine an expanded expansion state for a transportation mode interface element 314. Then, as shown in FIG. 3A, the dynamic-accordion-interface system 106 can provide for display, within a graphical user interface 312 of a requestor device 310, an accordion interface element for the transportation mode interface element 314 in an expanded state such that the nested transportation sub-options interface elements 316 are displayed.

As further illustrated in FIG. 3B, the dynamic-accordion-interface system 106 can utilize transportation features 318 (and/or requestor device information 320) to select expansion states 324c for transportation mode interface elements 324a and nested transportation sub-option interface elements 324b of a tiered-hierarchy of transportation option user interfaces elements 322. As shown in FIG. 3B, the dynamic-accordion-interface system 106 can determine a collapsed expansion state for a transportation mode interface element 330. Then, as shown in FIG. 3B, the dynamic-accordion-interface system 106 can provide for display, within a graphical user interface 328 of a requestor device 326, an accordion interface element 332 for the transportation mode interface element 330 in a collapsed state such that nested transportation sub-option interface elements 316 are hidden. As further shown in FIG. 3B, the dynamic-accordion-interface system 106 can provide for display, within a graphical user interface, the accordion interface element 332 to be operable to display or hide a second tier of nested transportation sub-options.

As an example, FIG. 3C illustrates the operability of an accordion interface element. For example, as shown in FIG. 3C the dynamic-accordion-interface system 106 provides for display, within a graphical user interface 336 of a requestor device 334, an accordion interface element 340a for a first tier transportation mode option interface element 338. As further shown in FIG. 3C, the dynamic-accordion-interface system 106 provides for display, within the graphical user interface 336, an additional first tier transportation mode option interface element 342 that does not include a second tier of transportation sub-option interface elements (e.g., based on a determination utilizing the transportation features).

Furthermore, as shown in FIG. 3C, upon receiving an indication of a selection of the accordion interface element 340a, the dynamic-accordion-interface system 106 expands (displays) a second tier of nested transportation sub-options 344a-344c under the first tier transportation mode option interface element 338. As shown in FIG. 3C, the expanded second tier of nested transportation sub-options 344a-344c provide granular options relating to the first tier transportation mode option interface element 338 within the same graphical user interface 336 without additional navigational steps. Indeed, the dynamic-accordion-interface system 106 generates an accordion-based GUI element that enables granularity of options within a limited screen space of a mobile device.

In addition, the dynamic-accordion-interface system 106 also provides for display, within the graphical user interface 336 of the requestor device 334, an accordion interface element 340b that is operable to hide the expanded second tier transportation sub-option interface elements 344a-344c. In particular, upon receiving an indication of a selection of the accordion interface element 340b, the dynamic-accordion-interface system 106 can collapse (hide) the second tier of nested transportation sub-options 344a-344c under the first tier transportation mode option interface element 338.

In some embodiments, the dynamic-accordion-interface system 106 provides for display, within a graphical user interface, an accordion selectable element that includes preview information for a nested transportation sub-option interface element (of a transportation sub-option). In particular, as shown in FIG. 3C, the dynamic-accordion-interface system 106 provides for display, within the graphical user interface 336, the accordion interface element 340a to include preview information for a transportation sub-option (e.g., the selected “pickup in 7 min” corresponding to the second tier transportation sub-option interface element 344b). Indeed, as shown in FIG. 3C, the preview information indicates a sub-option that is selected when the accordion interface element 340a is in a collapsed state and the second tier transportation sub-option interface elements 344a-344c are hidden.

Indeed, in one or more embodiments, the dynamic-accordion-interface system 106 can determine an expanded state and/or collapsed state for an accordion selectable element of a first tier transportation mode element based on the one or more transportation features (and/or requestor device information) described above. For example, the dynamic-accordion-interface system 106 can determine an expanded state (or collapsed state) based on determining that a nested transportation sub-option (or a first tier transportation mode) satisfies a threshold metric, requestor device preference, and/or an attribute of the weighted objective function (as described above). More specifically, the dynamic-accordion-interface system 106 can determine an expanded state (or collapsed state) based on transportation features (and/or requestor device information) to increase the likelihood of a selection of a nested transportation sub-option displayed within a requestor device.

In some embodiments, the dynamic-accordion-interface system 106 determines an expanded state and/or collapsed state for an accordion selectable element of a first tier transportation mode element based on a transportation mode being set as default (or static) by a requestor device (and/or the dynamic transportation matching system 104). Indeed, the dynamic-accordion-interface system 106 can set static expanded and/or collapsed states for specific transportation mode options. As an example, the dynamic-accordion-interface system 106 can determine that a particular transportation mode is set as a default transportation mode and position the transportation mode interface element (of the particular transportation mode) within a viewable region of a requestor device GUI and in an expanded state.

Additionally, as previously mentioned, the dynamic-accordion-interface system 106 can determine activation states for transportation sub-option interface elements upon determining an availability of a transportation sub-option based on transportation features. For example, FIGS. 4A-4C illustrate the dynamic-accordion-interface system 106 dynamically displaying second tier transportation sub-option interface elements based on activation states determined from changes in transportation features (and/or requestor device information). Indeed, as shown in FIGS. 4A-4C, the dynamic-accordion-interface system 106 can activate and/or deactivate second tier transportation sub-option interface elements based on availability of the sub-options as determined from changes in transportation features (and/or requestor device information).

For instance, FIG. 4A illustrates the dynamic-accordion-interface system 106 providing for display, within a graphical user interface 404 of a requestor device 402, a tiered-hierarchy of transportation option user interface elements including a first tier transportation mode interface element 406 and a second tier nested transportation sub-option interface element 408. Then, as shown in FIG. 4A, the dynamic-accordion-interface system 106 utilizes transportation features 410 and/or requestor device information 412 (e.g., monitored in real time or near-real time) to determine an availability of transportation sub-options in an act 414. Indeed, the dynamic-accordion-interface system 106 can determine that a particular transportation sub-option is available and/or unavailable based on the transportation features 410 (and/or the requestor device information 412).

Then, as shown in FIG. 4A, the dynamic-accordion-interface system 106 activates and/or deactivates a transportation sub-option interface element (in an act 416) based on the determined availability (from the act 414). To illustrate, in reference to FIG. 4A, the dynamic-accordion-interface system 106 can determine that a transportation sub-option (in the act 414) corresponding to the second tier nested transportation sub-option interface element 408 is unavailable. As a result, as shown in FIG. 4B, the dynamic-accordion-interface system 106 deactivates the second tier nested transportation sub-option interface element 408 in the transitional graphical user interfaces 418 and 426 (corresponding to the graphical user interface 404) of the requestor device 402 (e.g., by removing or making a transportation sub-option interface element non-selectable).

As shown in FIG. 4B, in some cases, the dynamic-accordion-interface system 106 provides for display, within the graphical user interface 418, a second tier nested transportation sub-option interface element 422 under the first tier transportation mode interface element 420 with a second tier nested transportation sub-option interface element (from the graphical user interface 404) removed. In some instances, as shown in FIG. 4B, the dynamic-accordion-interface system 106 provides for display, within the graphical user interface 426, a second tier nested transportation sub-option interface element 428 that is non-selectable based on a determined unavailability of the corresponding transportation sub-option. Indeed, the dynamic-accordion-interface system 106 can deactivate various numbers of second tier transportation sub-option interface elements (e.g., by removing or making non-selectable) based on determined unavailability of corresponding transportation sub-options from changes in transportation features and/or requestor device information. In some embodiments, upon deactivating a threshold number of transportation sub-options (or each transportation sub-option) of a transportation mode, the dynamic-accordion-interface system 106 can collapse an accordion interface element corresponding to the transportation mode.

In some embodiments, the dynamic-accordion-interface system 106 determines that a particular transportation sub-option is available based on the transportation features (and/or the requestor device information) and activates a second tier nested transportation sub-option interface element for the available transportation sub-option. For example, as shown in FIG. 4C, the dynamic-accordion-interface system 106 provides for display, within a graphical user interface 432 of a requestor device 430, a tiered-hierarchy of transportation option user interface elements including a first tier transportation mode interface element 434 and a second tier nested transportation sub-option interface element 436. Then, as shown in FIG. 4C, upon determining an availability of a transportation sub-option (in the act 442) based on transportation features 438 (and/or requestor device information 440), the dynamic-accordion-interface system 106 activates (in the act 444) a second tier nested transportation sub-option interface element 452 in the transitional graphical user interfaces 448 (corresponding to the graphical user interface 432) of the requestor device 430 (e.g., by adding a transportation sub-option interface element).

For example, the dynamic-accordion-interface system 106 can utilize the transportation features and/or requestor device information to determine the availability or feasibility of a transportation mode option and/or a transportation sub-option. In some instances, based on changes of transportation features (and/or requestor device information) in the geographical area (e.g., provider device availability, transportation request cost, requestor device location changes, time changes, weather, traffic), the dynamic-accordion-interface system 106 can determine that a transportation mode (or transportation sub-option) is unavailable. Likewise, in some embodiments, the dynamic-accordion-interface system 106 determines that a transportation mode (or transportation sub-option) is available in a geographical area based on changes of transportation features (and/or requestor device information).

As previously mentioned, the dynamic-accordion-interface system 106 can also utilize monitored transportation features (and/or requestor device information) to rank transportation sub-options and utilize the rankings to determine a tiered-hierarchy of transportation option user interface elements. For example, FIGS. 5A and 5B illustrate the dynamic-accordion-interface system 106 ranking transportation sub-options and utilizing the rankings to determine various attributes (or elements) of tiered-hierarchy of transportation option user interface elements. Indeed, as shown in FIGS. 5A and 5B, the dynamic-accordion-interface system 106 can utilize rankings of transportation sub-options to determine expansion states, an order (or arrangement) of transportation mode interface elements, or orders and/or selections of transportation sub-option interface elements.

In some embodiments, the dynamic-accordion-interface system 106 determines a ranking for transportation sub-options by ordering transportation sub-options based on metrics determined from transportation features and/or requestor device information (as described above). In particular, the dynamic-accordion-interface system 106 orders transportation sub-options to designate which transportation sub-option is most likely to be selected and which transportation sub-option is least likely to be selected by a requestor operating a requestor device. For example, the dynamic-accordion-interface system 106 can determine a metric (based on analyzing transportation features, requestor device information, and/or a weighted objective function) for each transportation sub-option available within a geographical area. Then, the dynamic-accordion-interface system 106 can rank the transportation sub-options using the metrics (e.g., from a highest to lowest metric value).

In some cases, the dynamic-accordion-interface system 106 utilizes the transportation features and/or requestor device information to rank the transportation sub-options based on transportation sub-options meeting or having particular attributes from the transportation features and/or requestor device information. For instance, the dynamic-accordion-interface system 106 can determine that a transportation sub-option is indicated as a requestor preferred transportation sub-option (in association with the requestor device). Accordingly, the dynamic-accordion-interface system 106 can order the transportation sub-option as a higher ranking (or prioritized) transportation sub-option. As another example, the dynamic-accordion-interface system 106 can determine that a transportation sub-option is rarely selected in a geographical area based on historical activity and, as a result, can deprioritize (or reduce the ranking) of the transportation sub-option. Although one or more embodiments herein describe the dynamic-accordion-interface system 106 ranking transportation sub-options based on transportation features and/or requestor device information, in some cases, the dynamic-accordion-interface system 106 can rank transportation mode options.

In one or more implementations, the dynamic-accordion-interface system 106 utilizes a machine learning model to rank a set of transportation sub-options. For example, the dynamic-accordion-interface system 106 can utilize a machine learning model that analyzes transportation features (and/or requestor device information) to determine a ranked order for transportation sub-options. For instance, the machine learning model can predict which transportation sub-option is most likely to be selected by a requestor user of a requestor device using the specific transportation features (and/or requestor device information). Then, the dynamic-accordion-interface system 106 can rank the transportation sub-options based on the predicted likelihoods of selection. In some embodiments, the dynamic-accordion-interface system 106 can utilize a machine learning model such as, but not limited to, a model that applies a stochastic gradient descent, linear regression models, random forest regression models, long short-term memory (LSTM) based recurrent neural networks, convolutional neural network models, Sequential Monte Carlo (“SMC”) methods, Monte Carlo simulations, such as Markov chain Monte Carlo (“MCMC”), or Hidden Markov Models (“HMI”).

To train the machine learning model, in one or more embodiments, the dynamic-accordion-interface system 106 utilizes historical transportation features (and/or historical requestor device information) that includes historical data on ground truth selections of transportation sub-options. Indeed, the dynamic-accordion-interface system 106 can utilize the historical transportation features with the machine learning model to determine a ranked order for transportation sub-options. Then, the dynamic-accordion-interface system 106 can compare the predicted ranked order of transportation sub-options with the historical data on ground truth selections of transportation sub-options to determine a loss value between the predictions and the ground truth data. For example, the loss can indicate the accuracy at which the machine learning model correctly predicts a rank of a transportation sub-option when compared to the transportation sub-option that was actually selected (from the ground truth data). Then, the dynamic-accordion-interface system 106 can utilize the loss to train the machine learning model (e.g., adjusting parameters of a model, learning parameters of a model, back propagation).

As shown in FIG. 5A, the dynamic-accordion-interface system 106 utilizes monitored transportation features 502 (and/or requestor device information 504) to determine a ranking (as described above) for and ordering transportation sub-options. For example, as shown in FIG. 5A, the dynamic-accordion-interface system 106 can determine a ranked order of transportation sub-options (e.g., transportation sub-option 1, transportation sub-option 7, transportation sub-option 20 . . . transportation sub-option 14). Based on the determined ranking (from the act 506), the dynamic-accordion-interface system 106 can determine tiered-hierarchy of transportation option user interface elements in an act 508.

In certain instances, the dynamic-accordion-interface system 106 (in the act 508) can select transportation mode interface elements to include based on the rankings of the transportation sub-options (from the act 506). For example, the dynamic-accordion-interface system 106 can select transportation mode options to display based on the rankings of particular transportation sub-options (under the transportation mode options) satisfying a threshold rank. For instance, the dynamic-accordion-interface system 106 can include a transportation mode interface element when one or more corresponding transportation sub-options are ranked above a determined rank threshold (e.g., within a top 5, top 10, top 15 of transportation sub-options).

In some embodiments, the dynamic-accordion-interface system 106 selects nested transportation sub-option interface elements (in the act 508) to display based on the rankings of the transportation sub-options (from the act 506). For instance, the dynamic-accordion-interface system 106 can select a set of transportation sub-option interface elements (in the act 508) for transportation sub-options that satisfy a threshold rank (to place within a first tier transportation mode option interface element). For example, the dynamic-accordion-interface system 106 can include nested transportation sub-option interface element when corresponding transportation sub-options are ranked above a determined threshold rank (e.g., top 5, top 10, top 15 of transportation sub-options).

For example, as shown in FIGS. 5A and 5B, the tiered-hierarchy of transportation option user interface elements (from the act 508) can include configurations for an expansion state of transportation mode interface elements 510. To illustrate, the dynamic-accordion-interface system 106 provides, for display within a graphical user interface 518 of a requestor device 516, an accordion interface element 520 of a first tier transportation mode option interface element in an expanded state to display a second tier of nested transportation sub-option interface elements 522 when a ranking corresponding to the transportation sub-options (for the nested transportation sub-option interface elements 522) satisfy a threshold rank (e.g., 2 of the top 4 options corresponding to this particular transportation mode). As further shown in FIG. 5B, the dynamic-accordion-interface system 106 can provide, for display within the graphical user interface 518, no accordion interface element for a first tier transportation mode option interface element 524 when a ranking corresponding to transportation sub-options (for the transportation mode option interface element 524) do not satisfy a threshold ranking.

As another example, as shown in FIGS. 5A and 5B, the tiered-hierarchy of transportation option user interface elements (from the act 508) can include configurations for an order of transportation mode interface elements 512. For instance, as shown in FIG. 5B, the dynamic-accordion-interface system 106, provides for display, within a graphical user interface 528 of a requestor device 526, a first tier transportation mode option interface element 530 positioned within a viewable region of the graphical user interface 528 when corresponding transportation sub-options for the first tier transportation mode option interface element 530 satisfy a threshold rank. In addition, as also shown in FIG. 5B, the dynamic-accordion-interface system 106 provides for display, within the graphical user interface 528, a first tier transportation mode option interface element 532 positioned (or placed) on a non-viewable region of the graphical user interface 528 based on rankings of corresponding transportation sub-options not satisfying a threshold rank.

In some embodiments, the dynamic-accordion-interface system 106 selects the place (or position) of transportation mode interface elements based on a ranking of transportation mode options utilizing the transportation features. In particular, the dynamic-accordion-interface system 106 can determine a ranked order of transportation mode options based on transportation features (and/or requestor device information) as described above. Then, the dynamic-accordion-interface system 106 can utilize the ranked transportation mode options to select which transportation mode option interface element to place in a viewable region versus a non-viewable region within a graphical user interface. For example, the dynamic-accordion-interface system 106 can utilize the ranked transportation mode options to select a higher ranked transportation mode option for the viewable region and a lower ranked transportation mode option for the non-viewable region. A user can then scroll to the non-viewable region to view the lower ranked transportation mode option.

Additionally, as shown in FIGS. 5A and 5B, the tiered-hierarchy of transportation option user interface elements (from the act 508) can include configurations for an order (and/or selections) of transportation sub-option interface elements 514. For instance, as shown in FIG. 5B, the dynamic-accordion-interface system 106, in the graphical user interface 536 of a requestor device 534, utilizes rankings of transportation sub-options to determine an order of display for the second tier of nested transportation sub-option interface elements 538 and 540 (e.g., in comparison to the graphical user interface 528). Indeed, the dynamic-accordion-interface system 106 can provide for display, within a graphical user interface, various nested transportation sub-option interface elements in various orders based on a ranking of corresponding transportation sub-options.

Moreover, as shown in FIG. 5B, the dynamic-accordion-interface system 106 can select (e.g., preselect) a transportation sub-option interface element based on a ranking of the transportation sub-options. For example, as shown in FIG. 5B, upon determining that the nested transportation sub-option interface element 540 is ranked higher than the nested transportation sub-option interface element 538, the dynamic-accordion-interface system 106 can preselect the nested transportation sub-option interface element 540. Indeed, the dynamic-accordion-interface system 106 can preselect a nested transportation sub-option interface element based on a rank of the corresponding sub-option indicating that the nested transportation sub-option interface element will likely be selected by a requestor user corresponding to a requestor device.

In some cases, the dynamic-accordion-interface system 106 determines that a transportation mode does not have a number of transportation sub-options that satisfies a threshold number of transportation sub-options. Upon determining that the number of transportation sub-options does not satisfy the threshold number of transportation sub-options, the dynamic-accordion-interface system 106 can forego displaying an accordion interface element for the transportation mode corresponding to the number of transportation sub-options. In addition, in some embodiments, the dynamic-accordion-interface system 106 can identify an additional transportation mode option that includes a number of transportation sub-options that satisfy the threshold number of transportation sub-options (e.g., to display the additional transportation mode option interface element with nested interface elements for the corresponding transportation sub-options).

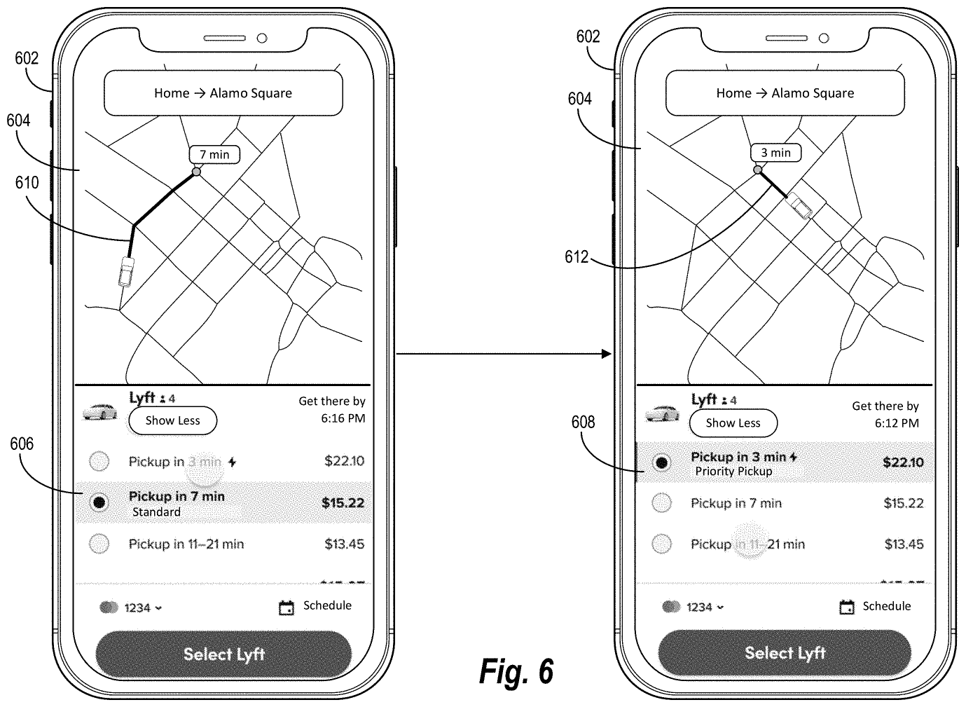

In addition to providing for display, within a graphical user interface, a tiered-hierarchy of transportation option user interface elements, the dynamic-accordion-interface system 106 can also modify (or update) a graphical user interface based on a selection of a nested transportation sub-option interface element. For instance, as shown in FIG. 6, the dynamic-accordion-interface system 106 provides for display, within a graphical user interface 604 of a requestor device 602, a selected transportation sub-option interface element 606 and provider device route information 610 corresponding to the transportation sub-option. Upon selection of another transportation sub-option interface element 608, the dynamic-accordion-interface system 106 provides for display, within the graphical user interface 604, different provider device route information 612 corresponding to the other transportation sub-option interface element 608.

Although one or more embodiments describes the dynamic-accordion-interface system 106 providing for display, within a graphical user interface, transportation mode option interface elements and transportation sub-option interface elements for transportation service requests, the dynamic-accordion-interface system 106 can provide various types of options and sub-options within a tiered-hierarchy of user interface elements. For example, the dynamic-accordion-interface system 106 can provide options and sub-options within a tiered-hierarchy of user interface elements for various services such as, but not limited to, a shared or non-shared type of transportation service, a delivery (e.g., parcel delivery) transportation service, a delayed transportation service (e.g., delayed transportation with a different transportation value or price), vehicle rental services, food delivery services, public transit service, grocery delivery services, and/or bicycle (or other vehicle) rentals.

For example, the dynamic-accordion-interface system 106 can provide for display a first tier of option interface elements for vehicle types and a second tier of nested sub-option interface elements for different vehicles under the vehicle type (e.g., for car rental services). In some embodiments, the dynamic-accordion-interface system 106 can provide for display a first tier of option interface elements for package delivery dates and a second tier of nested sub-option interface elements for different package sizes (e.g., small, medium, large packages). Furthermore, in some instances, the dynamic-accordion-interface system 106 can provide for display a first tier of option interface elements for a “shared” transportation mode option interface element and a second tier of nested transportation sub-option interface elements for “shared” transportation mode options.

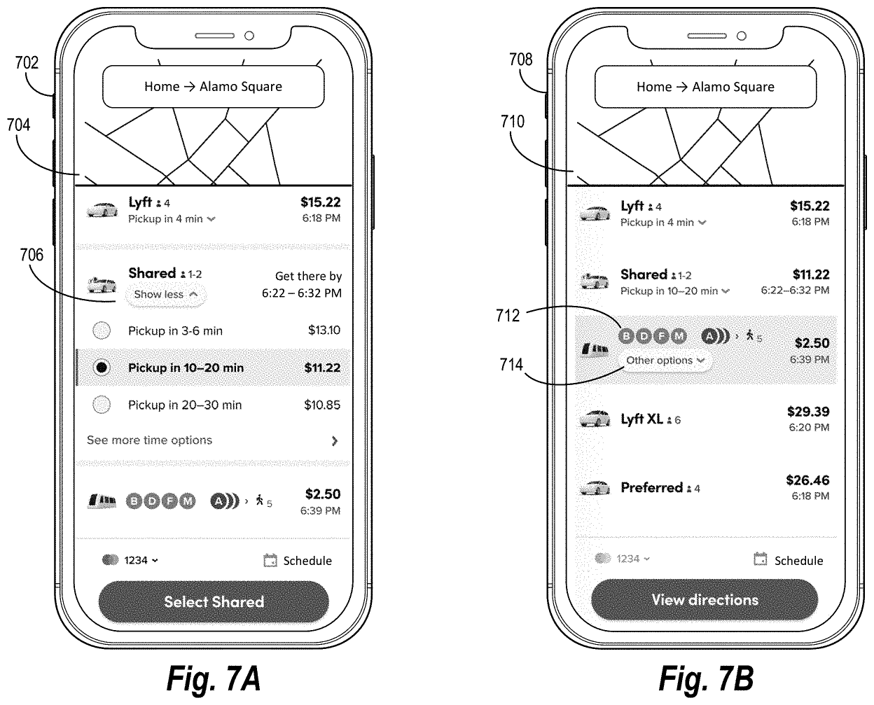

To illustrate, FIGS. 7A and 7B, the dynamic-accordion-interface system 106 can provide for display, within a graphical user interface, second tier nested sub-option interface elements for various types of first tier option interface elements. For example, as shown in FIG. 7A, the dynamic-accordion-interface system 106 provides for display, within a graphical user interface 704 of a requestor device 702, a second tier nested transportation sub-option interface elements for a transportation mode option interface element 706 corresponding to a “shared” transportation mode option.

In some embodiments, the dynamic-accordion-interface system 106 can provide for display a first tier of option interface elements for public transit modes and a second tier of nested sub-option interface elements. For example, as shown in FIG. 7B, the dynamic-accordion-interface system 106 provides for display, within a graphical user interface 710 of a requestor device 708, an accordion interface element 714 for a first tier transportation mode option interface element 712 (corresponding to a “transit” transportation mode option). Indeed, in reference to FIG. 7B, in some embodiments, the accordion interface element 714 is operable to display or hide nested transportation sub-option interface elements for the “transit” transportation mode option. In certain instances, the nested transportation sub-option interface elements for the “transit” transportation mode option can include sub-options for, but not limited to, scheduled times of the public transit modes, departing platforms, seating options, and/or luggage options.

Furthermore, although one or more embodiments described for requestor device, the dynamic-accordion-interface system 106 can also utilize a tiered-hierarchy of transportation option user interface elements within graphical user interfaces of provider devices. For example, the dynamic-accordion-interface system 106 can provide for display, within a graphical user interface of a provider device, a tiered-hierarchy of option user interface elements having a first tier of pending transportation requests and a second tier of nested transportation request sub-options (e.g., contact options, report options, message options). In some embodiments, the dynamic-accordion-interface system 106 can provide for display, within a graphical user interface of a provider device, a tiered-hierarchy of option user interface elements having a first tier of scheduled transportation service slots (e.g., scheduled shifts) and a second tier of nested transportation request sub-options (e.g., dates, times, transportation service types).

Additionally, although one or more embodiments herein illustrate a second tier of nested transportation sub-option interface elements, the dynamic-accordion-interface system 106 can include various numbers of nested interface elements that are expandable and/or collapsible. For instance, the dynamic-accordion-interface system 106 can provide for display, within a graphical user interface, a third tier of nested transportation sub-option interface elements for a particular transportation sub-option interface element from the second tier.

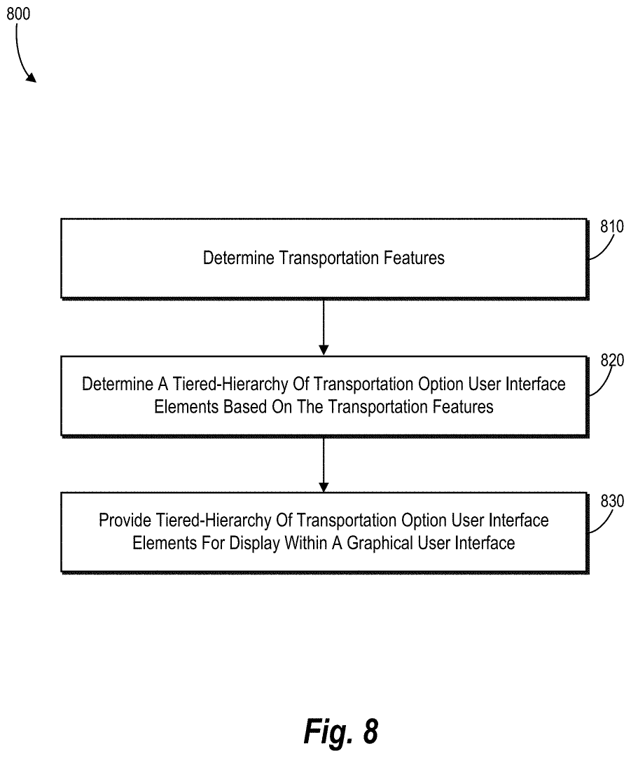

Turning now to FIG. 8, this figure shows a flowchart of a series of acts 800 for displaying a tiered-hierarchy of transportation option user interface elements in accordance with one or more implementations. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by the one or more processors, cause a computing device to perform the acts depicted in FIG. 8. In still further embodiments, a system can perform the acts of FIG. 8.

As shown in FIG. 8, the series of acts 800 include an act 810 of determining transportation features. In particular, the act 810 can include determining transportation features from a plurality of provider devices and requestor devices corresponding to a transportation matching system. For example, transportation features can include locations of the plurality of provider devices, a number of online provider devices, or a number of transportation requests from a plurality of requestor devices. In addition, the act 810 can include determining information corresponding to a requestor device. For instance, information corresponding to a requestor device can include a location of a requestor device or historical activity of the requestor device.

As further shown in FIG. 8, the series of acts 800 include an act 820 of determining a tiered-hierarchy of transportation option user interface elements based on the transportation features. In particular, the act 820 can include determining, based on transportation features, a tiered-hierarchy of transportation option user interface elements including a first tier of one or more transportation mode interface elements and a second tier of nested transportation sub-option interface elements. In some embodiments, the act 820 includes selecting, based on transportation features, an expanded state for a set of nested transportation sub-option interface elements corresponding to a second tier for a particular transportation mode interface element. In some cases, the act 820 includes selecting, based on transportation features, a collapsed state for a set of nested transportation sub-option interface elements corresponding to a second tier for a particular transportation mode interface element.

Furthermore, the act 820 can include determining a ranking of a set of transportation sub-options for nested transportation sub-option interface elements corresponding to a second tier for a particular transportation mode interface element based on transportation features. In addition, the act 820 can include determining a tiered-hierarchy of transportation option user interface elements based on the ranking. In certain instances, the act 820 can include determining a ranking of a set of transportation mode options for transportation mode interface elements corresponding to a first tier based on transportation features. Moreover, the act 820 can include selecting a particular transportation mode interface element for placement on a non-viewable region of a graphical user interface of a requestor device based on the ranking.

As also shown in FIG. 8, the series of acts 800 include an act 830 of providing tiered-hierarchy of transportation option user interface elements for display within a graphical user interface. In particular, the act 830 can include providing a tiered-hierarchy of transportation option user interface elements for display, within a graphical user interface of a requestor device, by providing one or more accordion selectable elements corresponding to a first tier operable to display and hide a second tier. In some cases, the act 830 can include providing, for display within a graphical user interface of a requestor device, a set of nested transportation sub-option interface elements in an expanded state. Furthermore, the act 830 can include providing, for display within a graphical user interface of a requestor device, a set of nested transportation sub-option interface elements in a collapsed state. For example, a first tier of one or more transportation mode interface elements can include selectable transportation modes. Additionally, a second tier of nested transportation sub-option interface elements can include a plurality of transportation pickup times and corresponding transportation request rates.

Furthermore, in some cases, the act 830 can include providing, for display within a graphical user interface of a requestor device, a set of nested transportation sub-option interface elements corresponding to a second tier for a particular transportation mode interface element. Additionally, the act 830 can include determining, based on transportation features, that a transportation sub-option is unavailable. In addition, the act 830 can include deactivating a transportation sub-option interface element corresponding to an unavailable transportation sub-option within a graphical user interface of a requestor device. For example, the act 830 can include deactivating a transportation sub-option interface element within a graphical user interface of a requestor device by removing a transportation sub-option interface element.

Moreover, in some instances, the act 830 can include determining, based on transportation features, an additional transportation sub-option is available. Furthermore, the act 830 can include activating an additional transportation sub-option interface element corresponding to an additional transportation sub-option within a graphical user interface of a requestor device. Additionally, the act 830 can include providing, for display within a graphical user interface of a requestor device, a particular accordion selectable element comprising preview information for a particular nested transportation sub-option interface element.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that the dynamic-accordion-interface system 106 (or the dynamic transportation matching system 104) can comprise implementations of a computing device, including, but not limited to, the devices or systems illustrated in the previous figures. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output (“I/O”) interface 908, which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that couples components of computing device 900 to each other.

FIG. 10 illustrates an example network environment 1000 of a transportation matching system 1002 (e.g., the dynamic transportation matching system 104). The network environment 1000 includes a client device 1006, a transportation matching system 1002, and a vehicle subsystem 1008 connected to each other by a network 1004. Although FIG. 10 illustrates a particular arrangement of the client device 1006, transportation matching system 1002, vehicle subsystem 1008, and network 1004, this disclosure contemplates any suitable arrangement of client device 1006, transportation matching system 1002, vehicle subsystem 1008, and network 1004. As an example, and not by way of limitation, two or more of client device 1006, transportation matching system 1002, and vehicle subsystem 1008 communicate directly, bypassing network 1004. As another example, two or more of client device 1006, transportation matching system 1002, and vehicle subsystem 1008 may be physically or logically co-located with each other in whole or in part. Moreover, although FIG. 10 illustrates a particular number of client devices 1006, transportation matching systems 1002, vehicle subsystems 1008, and networks 1004, this disclosure contemplates any suitable number of client devices 1006, transportation matching systems 1002, vehicle subsystems 1008, and networks 1004. As an example, and not by way of limitation, network environment 1000 may include multiple client device 1006, transportation matching systems 1002, vehicle subsystems 1008, and networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, transportation matching system 1002, and vehicle subsystem 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at client device 1006 to access network 1004. A client device 1006 may enable its user to communicate with other users at other client devices 1006.

In particular embodiments, client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 1006 one or more Hyper Text Markup Language (“HTML”) files responsive to the HTTP request. Client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 1002 may be a network-addressable computing system that can host a transportation matching network. Transportation matching system 1002 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 1002. In addition, the transportation matching system may manage identities of service requesters such as users/requesters. In particular, the transportation matching system 1002 may maintain requester data such as driving/riding histories, personal data, or other user data in addition to navigation and/or traffic management services or other location services (e.g., GPS services).

In particular embodiments, the transportation matching system 1002 may manage transportation matching services to connect a user/requester with a vehicle and/or provider. By managing the transportation matching services, the transportation matching system 1002 can manage the distribution and allocation of resources from the vehicle subsystem 1008 and user resources such as GPS location and availability indicators, as described herein.

Transportation matching system 1002 may be accessed by the other components of network environment 1000 either directly or via network 1004. In particular embodiments, transportation matching system 1002 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 1002 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 1002 to manage, retrieve, modify, add, or delete, the information stored in data store.

In particular embodiments, transportation matching system 1002 may provide users with the ability to take actions on various types of items or objects, supported by transportation matching system 1002. As an example, and not by way of limitation, the items and objects may include transportation matching networks to which users of transportation matching system 1002 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 1002 or by an external system of a third-party system, which is separate from transportation matching system 1002 and coupled to transportation matching system 1002 via a network 1004.

In particular embodiments, transportation matching system 1002 may be capable of linking a variety of entities. As an example, and not by way of limitation, transportation matching system 1002 may enable users to interact with each other or other entities, or to allow users to interact with these entities through an application programming interfaces (“API”) or other communication channels.

In particular embodiments, transportation matching system 1002 may include a variety of servers, sub-systems, programs, modules, logs, and data stores. In particular embodiments, transportation matching system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Transportation matching system 1002 may also include suitable components such as network interfaces, security mechanisms, load balancers, failover servers, management-and-network-operations consoles, other suitable components, or any suitable combination thereof. In particular embodiments, transportation matching system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between transportation matching system 1002 and one or more client devices 1006. An action logger may be used to receive communications from a web server about a user's actions on or off transportation matching system 1002. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of transportation matching system 1002. A privacy setting of a user determines how particular information associated with a user can be shared. The authorization server may allow users to opt in to or opt out of having their actions logged by transportation matching system 1002 or shared with other systems, such as, for example, by setting appropriate privacy settings. Third-party-content-object stores may be used to store content objects received from third parties. Location stores may be used for storing location information received from client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—i.e., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—i.e., split up throughout the vehicle subsystem 1008 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the transportation matching system 1002. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method for generating efficient user interfaces for computing devices, comprising:
determining transportation features from a plurality of provider devices and requestor devices corresponding to a transportation matching system;
determining, based on the transportation features, a tiered-hierarchy of transportation option user interface elements comprising a first tier of one or more transportation mode interface elements and a second tier of nested transportation sub-option interface elements; and
providing the tiered-hierarchy of transportation option user interface elements for display, within a graphical user interface of a requestor device, by providing one or more accordion selectable elements corresponding to the first tier operable to display and hide the second tier.

2. The computer-implemented method of claim 1, further comprising:
selecting, based on the transportation features, an expanded state for a set of nested transportation sub-option interface elements corresponding to the second tier for a particular transportation mode interface element; and
providing, for display within the graphical user interface of the requestor device, the set of nested transportation sub-option interface elements in the expanded state.

3. The computer-implemented method of claim 1, further comprising:
selecting, based on the transportation features, a collapsed state for a set of nested transportation sub-option interface elements corresponding to the second tier for a particular transportation mode interface element; and
providing, for display within the graphical user interface of the requestor device, the set of nested transportation sub-option interface elements in the collapsed state.

4. The computer-implemented method of claim 1, further comprising:
providing, for display within the graphical user interface of the requestor device, a set of nested transportation sub-option interface elements corresponding to the second tier for a particular transportation mode interface element;
determining, based on the transportation features, that a transportation sub-option is unavailable; and
deactivating a transportation sub-option interface element corresponding to the unavailable transportation sub-option within the graphical user interface of the requestor device.

5. The computer-implemented method of claim 4, further comprising deactivating the transportation sub-option interface element within the graphical user interface of the requestor device by removing the transportation sub-option interface element.

6. The computer-implemented method of claim 4, further comprising:
determining, based on the transportation features, an additional transportation sub-option is available; and
activating an additional transportation sub-option interface element corresponding to the additional transportation sub-option within the graphical user interface of the requestor device.

7. The computer-implemented method of claim 1, further comprising:
determining a ranking of a set of transportation sub-options for nested transportation sub-option interface elements corresponding to the second tier for a particular transportation mode interface element based on the transportation features; and
determining the tiered-hierarchy of transportation option user interface elements based on the ranking.

8. The computer-implemented method of claim 1, wherein the transportation features comprise locations of the plurality of provider devices, a number of online provider devices, or a number of transportation requests from the plurality requestor devices.

9. The computer-implemented method of claim 1, wherein:
the first tier of the one or more transportation mode interface elements comprises selectable transportation modes; and
the second tier of the nested transportation sub-option interface elements comprise a plurality of transportation pickup times and corresponding transportation request rates.

10. A non-transitory computer-readable medium storing instructions that, when executed by at least one processor, cause a computing device to:
determine transportation features from a plurality of provider devices and requestor devices corresponding to a transportation matching system;
determine, based on the transportation features, a tiered-hierarchy of transportation option user interface elements comprising a first tier of one or more transportation mode interface elements and a second tier of nested transportation sub-option interface elements; and
provide the tiered-hierarchy of transportation option user interface elements for display, within a graphical user interface of a requestor device, by providing one or more accordion selectable elements corresponding to the first tier operable to display and hide the second tier.

11. The non-transitory computer-readable medium of claim 10, further comprising instructions that, when executed by the at least one processor, cause the computing device to:
select, based on the transportation features, an expanded state for a set of nested transportation sub-option interface elements corresponding to the second tier for a particular transportation mode interface element; and
provide, for display within the graphical user interface of the requestor device, the set of nested transportation sub-option interface elements in the expanded state.

12. The non-transitory computer-readable medium of claim 11, further comprising instructions that, when executed by the at least one processor, cause the computing device to select the expanded state for the set of nested transportation sub-option interface elements based on information corresponding to the requestor device, wherein the information corresponding to the requestor device comprises a location of the requestor device or historical activity of the requestor device.

13. The non-transitory computer-readable medium of claim 10, further comprising instructions that, when executed by the at least one processor, cause the computing device to:
select, based on the transportation features, a collapsed state for a set of nested transportation sub-option interface elements corresponding to the second tier for a particular transportation mode interface element; and
provide, for display within the graphical user interface of the requestor device, the set of nested transportation sub-option interface elements in the collapsed state.

14. The non-transitory computer-readable medium of claim 10, further comprising instructions that, when executed by the at least one processor, cause the computing device to:
provide, for display within the graphical user interface of the requestor device, a set of nested transportation sub-option interface elements corresponding to the second tier for a particular transportation mode interface element;
determine, based on the transportation features, that a transportation sub-option is unavailable; and
deactivate a transportation sub-option interface element corresponding to the transportation sub-option within the graphical user interface of the requestor device.

15. The non-transitory computer-readable medium of claim 10, wherein the transportation features comprise locations of the plurality of provider devices, a number of online provider devices, or a number of transportation requests from the plurality requestor devices.

16. A system comprising:
at least one processor; and
at least one non-transitory computer-readable storage medium storing instructions that, when executed by the at least one processor, cause the system to:
determine transportation features from a plurality of provider devices and requestor devices corresponding to a transportation matching system;
determine, based on the transportation features, a tiered-hierarchy of transportation option user interface elements comprising a first tier of one or more transportation mode interface elements and a second tier of nested transportation sub-option interface elements; and
provide the tiered-hierarchy of transportation option user interface elements for display, within a graphical user interface of a requestor device, by providing one or more accordion selectable elements corresponding to the first tier operable to display and hide the second tier.

17. The system of claim 16, further comprising instructions that, when executed by the at least one processor, cause the system to:
select, based on the transportation features, an expanded state for a set of nested transportation sub-option interface elements corresponding to the second tier for a particular transportation mode interface element; and
provide, for display within the graphical user interface of the requestor device, the set of nested transportation sub-option interface elements in the expanded state.

18. The system of claim 16, further comprising instructions that, when executed by the at least one processor, cause the system to:
provide, for display within the graphical user interface of the requestor device, a set of nested transportation sub-option interface elements corresponding to the second tier for a particular transportation mode interface element;
determine, based on the transportation features, that a transportation sub-option is unavailable; and
deactivate a transportation sub-option interface element corresponding to the transportation sub-option within the graphical user interface of the requestor device.

19. The system of claim 16, further comprising instructions that, when executed by the at least one processor, cause the system to provide, for display within the graphical user interface of the requestor device, a particular accordion selectable element comprising preview information for a particular nested transportation sub-option interface element.

20. The system of claim 16, further comprising instructions that, when executed by the at least one processor, cause the system to:
determine a ranking of a set of transportation mode options for transportation mode interface elements corresponding to the first tier based on the transportation features; and
select a particular transportation mode interface element for placement on a non-viewable region of the graphical user interface of the requestor device based on the ranking.
